(19) United States
(12) Patent Application Publication
(10) Pub. No.: US 2008/0276300 A1
(43) Pub. Date: Nov. 6, 2008

(54) Program Execution Device

(75) Inventor: Satoshi Terao, New Jersey, NJ (US)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/598,935

(22) PCT Filed: Jan. 6, 2006
(86) PCT No.: PCT/JP2006/300075

§ 371 Date: Sep. 15, 2006

(30) Foreign Application Priority Data
Jan. 17, 2005 (JP) 2005/009676

(51) Int. Cl. G06F 15/173; G06F 21/00

(52) U.S. Cl. 726/3; 709/223

(57) ABSTRACT

To provide a program execution device which is capable of notifying time and information related to download and activation of a program.

The AM (1205b) of a terminal device includes: a program activation history obtainment unit (2002) which obtains history information of a program which has been downloaded and activated; a program activation time measurement unit (2004) which measures the time needed for download (download time) of the program and the time needed for activation (activation time) of the program; and a program activation information notification unit (2005) which notifies the activation waiting time based on the history information of the program.

### TECHNICAL FIELD

The present invention relates to a program execution device which downloads a program and executes the program. The present invention particularly relates to downloading a program and activating the program.

### BACKGROUND ART

A digital television has a function of downloading a program and activating the program. Such function is described in the DVB-MHP specifications such as “ETSI TS 101 812 V1. 2. 1 DVB-MHP specifications 1. 0. 2.” A program is associated with a service in an Application Information Table (AIT). When a service is selected, a program associated with the service is downloaded and activated based on the AIT.

On the other hand, for example, Patent Reference 1 has proposed: an operation history collection system which is capable of properly collecting user's content viewing and operation history; an operation history collection server; an operation history collection method; an operation history collection program; and a recording medium on which a content providing program is recorded, even in the case where an operation for viewing a downloaded content is performed at a timing different from the download timing.

This operation history collection server performs: recording of user's viewing and operation history related to a content to be downloaded to the client; recording of user's viewing and operation history, which are operation history, to be uploaded from the client under control of a program by providing the program, a user ID and a content ID for uploading these viewing and operation history to the server; and recording of a content name and the user ID to be downloaded to the client as download history.
Patent Reference: Japanese Laid-Open Patent Application No. 2001-209603

### DISCLOSURE OF INVENTION

Problems that Invention is to Solve

When a user (such as a viewer) selects a service, a program is automatically downloaded and activated based on the AIT of the service. However, the user does not know the activation waiting time; that is, the time needed for the program to be activated. In addition, in the case where the program has already been held in a storage, the time needed for download and activation of the program is generally short, but a user does not know such state.

Hence, the present invention has been conceived considering the above problem, and aims to provide a program execution device which is capable of notifying a user of a time and information related to download and activation of a program.

### Means to Solve the Problems

In order to achieve the above-described object, the program execution device according to the present invention downloads a program and activates the program, and includes: a download time measurement unit which measures a download time of the program; an activation time measurement unit which measures an activation time of the program; a history information memory unit which stores, on a program-by-program basis, the measured download time and activation time as a part of history information; an activation management unit which receives an activation instruction for activating the program; a history information search unit which searches out history information of the program for which the activation instruction has been received; and a notification unit which predicts an activation waiting time based on the history information searched out by the history information search unit and notifies a user of the predicted activation waiting time. Here, the activation waiting time is a time from the reception of the activation instruction to an actual activation of the activation instruction.

This makes it possible to notify the user (viewer) of the activation waiting time; that is, the time from the reception of an activation instruction for activating a program to the actual activation of the program.

In addition, the notification unit of the program execution device may predict the activation waiting time which is a time obtained by adding the download time to the activation time included in the history information searched out by the history information search unit.

In the case where the program needs to be downloaded each time the program is activated or other cases, doing so makes it possible to notify the user of the activation waiting time; that is, the time from the reception of an activation instruction for activating a program to the actual activation of the program.

In addition, the program execution device may further include a holding unit which holds the downloaded program. The notification unit of the program execution device may predict, as the activation waiting time, a time obtained by adding the download time to the activation time included in the history information searched out by the history information search unit, in the case where the program for which the activation instruction has been received is not held in the holding unit, and may predict, as the activation waiting time, the activation time included in the history information searched out by the history information search unit, in the case where the program for which the activation instruction has been received is held in the holding unit.

In the case where a downloaded program can be held or other cases, doing so makes it possible to notify the user of the activation waiting time; that is, the time from the reception of an activation instruction for activating a program to the actual activation of the program, depending on whether the program to be activated has been held or not.

In addition, the program execution device may further include an authentication unit which authenticates the program depending on whether or not the program is held in the holding unit. The download time measurement unit of the program execution device may measure the download time including an authentication time required for the authentication unit to authenticate the program, in the case where the program for which the activation instruction has been received is not held in the holding unit, and may measure the activation time including the authentication time required for the authentication unit to authenticate the program, in the case where the program for which the activation instruction has been received is held in the holding unit. Even in the case where the downloaded program is authenticated, doing so makes it possible to notify the user of the activation waiting time; that is, the time from the reception of an activation instruction for activating a program to the actual activation of the program, depending on whether the program to be activated has been held or not.

In addition, the program execution device may further include an authentication judgment unit which judges whether or not the program needs to be authenticated by the authentication unit. The authentication unit of the program execution device may authenticate the program in the case where the authentication unit has judged that the program needs to be authenticated. Doing so makes it possible to perform authentication depending on a downloaded program.

In addition, the program execution device may include a history information update unit which updates the history information stored in the history information memory unit using (a) the newly measured activation time or (b) the download time and activation time. Doing so makes it possible to notify an activation waiting time based on the latest history information.

In addition, the notification unit of the program execution device may notify the user of the program name of the program in addition to the activation waiting time. Doing so makes it possible to notify the user of the program which requires the activation waiting time.

In addition, the notification unit of the program execution device may notify the activation waiting time using a countdown. Doing so makes it possible to notify the user of the remaining time to the time of the actual activation of the program.

In addition, the notification unit of the program execution device may predict that the activation waiting time is unknown, in the case where the history information of the program for which the activation instruction has been received cannot be obtained, as a result of the search performed by the history information search unit. Doing so makes it possible to notify the user that the program is to be downloaded and activated for the first time.

Note that the present invention can be realized not only as a program execution device like this but also as a program execution method including steps corresponding to the unique units provided with the program execution device and as a program causing a computer to execute these steps and the like. Additionally, such program can be distributed through a recording medium such as a CD-ROM, and a communication medium such as the Internet.

### Effects of the Invention

As clear from the above description, with the program execution device according to the present invention, it is possible to notify a user (viewer) of an activation waiting time; that is, the time from the reception of an activation instruction for activating a program to the actual activation of the program.

### BRIEF DESCRIPTION OF DRAWINGS

FIG. 1 is a configuration diagram of a first embodiment of the cable television system according to the present invention.

FIG. 2 is a diagram showing an example of the use of frequency bands used for communications between the headend and the terminal devices in the cable television system according to the present invention.

FIG. 3 is a diagram showing an example of the use of frequency bands used for communications between the headend and the terminal devices in the cable television system according to the present invention.

FIG. 4 is a diagram showing an example of the use of frequency bands used for communications between the headend and the terminal devices in the cable television system according to the present invention.

FIG. 5 is a configuration diagram of a terminal device in the cable television system according to the present invention.

FIG. 6 shows an example of an external view of a terminal device in the cable television system according to the present invention.

FIG. 7 is a configuration diagram of a hardware configuration of a POD according to the present invention.

FIG. 8 is a configuration diagram of a configuration of the program held in the POD according to the present invention.

FIG. 9 is a configuration diagram of a packet defined in the MPEG specifications.

FIG. 10 is a diagram showing an example of MPEG-2 transport streams.

FIG. 11 is a diagram showing an example of an external view of an input unit in the case where it is configured as a front panel.

FIG. 12 is a configuration diagram of a structure of the program held in a terminal device according to the present invention.

FIGS. 13A and 13B are diagrams each showing an example of display on a display screen according to the present invention.

FIG. 14 is a diagram showing an example of information held in a second memory unit according to the present invention.

FIG. 15A to 15C are diagrams each showing an example of information held in the first memory unit according to the present invention.

FIG. 16 is a schematic diagram showing the contents of a PMT prescribed in the MPEG-2 specifications according to the present invention.

FIG. 17 is a schematic diagram showing the contents of a PMT prescribed in the MPEG-2 specifications according to the present invention.

FIG. 18 is a schematic diagram showing the contents of an AIT according to the present invention.

FIG. 19 is a schematic diagram showing a file system transmitted in DSMCC format according to the present invention.

FIG. 20 is a block diagram showing constituent elements of an AM at the time of executing a function of: obtaining history of a time and information related to download and activation of a Java (trademark) program based on the AIT information of the present invention; and notifying a user of the history information.

FIGS. 21A and 21B are diagrams showing relationships between a download time, an activation time and an activation waiting time according to the present invention. FIG. 21A shows the relationship in the case of a program which needs to be downloaded, and FIG. 21B shows the relationship in the case of a program which does not need to be downloaded.

FIG. 22 is a flow chart indicating a sequence of actions of the program activation information management unit according to the present invention. The actions are: requesting for obtainment of activation history information of a Java (trademark) program, notifying the activation history information and the like of the Java program, and measuring the download and activation time.

FIG. 23 is a flow chart indicating a sequence of actions of a program activation history information obtainment unit at the time when the program activation information management unit of the present invention passes it activation AIT information and requests it to obtain the activation history information of the program.

FIG. 24 is a table which schematically shows an example of activation history information according to the present invention.

FIG. 25 is a flow chart indicating a sequence of actions of the program activation information notification unit at the time when the activation information management unit of the present invention passes it activation AIT information and activation history information, and requests it to notify them.

FIG. 26 is a display screen, according to the present invention, notifying a program name and a processing time of the program.

FIG. 27 is a flow chart indicating a sequence of actions of the program activation information notification unit at the time when the program information management unit of the present invention passes it the activation AIT information and requests it to notify the activation AIT information.

FIG. 28 is a display screen, according to the present invention, notifying that the program name and a processing time are unknown.

FIG. 29 is a flow chart indicating a sequence of actions of the program activation time measurement unit at the time when the program activation information management unit of the present invention requests it to perform measurement.

FIG. 30 is a schematic diagram of program activation time information according to the present invention.

FIG. 31 is a flow chart indicating a sequence of actions of the program activation information management unit of the present invention. The actions are: obtaining measurement results of the download and activation time of the Java (trademark) program and updating the activation history information.

FIG. 32 is a flow chart indicating a sequence of actions of the program activation time measurement unit at the time when the program activation information management unit 2001 of the present invention requests it to obtain the measurement results.

FIG. 33 is a flow chart indicating a sequence of actions of the program activation history information obtainment unit at the time when the program activation information management unit of the present invention passes it activation AIT information, and a download and activation time, and requests it to update the activation history information of the Java (trademark) program.

FIG. 34 is a schematic diagram showing the contents of an XAIT according to the present invention.

FIG. 35 is a diagram showing an example of information held in the second memory unit according to the present invention.

FIG. 36 is a block diagram showing constituent elements of an AM at the time of executing a function of: obtaining history of a time and information related to download and activation of a Java (trademark) program based on the XAIT information of the present invention; and notifying a user of the history information.

FIG. 37 is a flow chart indicating a sequence of actions of the program activation information management unit of the present invention. The actions are: requesting for obtaining activation history information of the Java (trademark) program, notifying the activation history information, and measuring download and activation time.

FIG. 38 is a flow chart indicating a sequence of actions of the program activation history information obtainment unit at the time when the program activation information management unit of the present invention passes it XAIT information and requests it to obtain the activation history information of the Java (trademark) program.

FIG. 39 is a table which schematically shows an example of activation history information according to the present invention.

FIG. 40 is a flow chart indicating a sequence of actions of the program activation information notification unit at the time when the program activation information management unit of the present invention passes it an XAIT and activation history information, and requests it to notify them.

FIG. 41 is a display screen, according to the present invention, notifying the program name and the calculated processing time.

FIG. 42 is a flow chart indicating a sequence of actions of the program activation information notification unit at the time when the program activation information management unit of the present invention passes it XAIT information and requests it to notify the XAIT information.

FIG. 43 is a display screen, according to the present invention, notifying that a program name and the processing time are unknown.

FIG. 44 is a flow chart indicating a sequence of actions of the program activation time measurement unit at the time when the program activation information management unit of the present invention requests it to perform measurement.

FIG. 45 is a schematic diagram showing an example of program activation time information according to the present invention.

FIG. 46 is a flow chart indicating a sequence of actions of the program activation information management unit of the present invention. The actions are: obtaining the measurement results of download time of the Java (trademark) program and updating the activation history information.

FIG. 47 is a flow chart indicating a sequence of actions of the program activation time measurement unit at the time when the program activation information management unit of the present invention requests it to obtain the measurement result of the download time.

FIG. 48 is a flow chart indicating a sequence of actions of the program activation history information obtainment unit 3503 at the time when the program activation information management unit of the present invention passes it XAIT information and the download time, and requests it to update the activation history information.

FIG. 49 is a flow chart indicating a sequence of actions of the program activation information management unit of the present invention. The actions are: obtaining the measurement result of the activation time of the Java (trademark) program and updating the activation history information.

FIG. 50 is a flow chart indicating a sequence of actions of the program activation time measurement unit at the time when the program activation information management unit of the present invention requests it to obtain the measurement result of the activation time.

FIG. 51 is a flow chart indicating a sequence of actions of the program activation history information obtainment unit at the time when the program activation information management unit of the present invention passes it XAIT information and an activation time, and requests it to update the activation history information of the Java (trademark) program.

FIG. 52 is a configuration diagram showing a configuration example of the configuration of a program held in a terminal device according to the present invention.

FIGS. 53A and 53B are diagrams each showing the relationships between an authentication time, a download time, an activation time, and an activation waiting time according to the present invention. FIG. 53A shows the relationship in the case of a program which needs to be downloaded, and FIG. 53B shows the relationship in the case of a program which does not need to be downloaded.

FIG. 54 is a table which schematically shows an example of activation history information according to the present invention.

FIG. 55 is a flow chart indicating a sequence of actions of the program activation time measurement unit at the time when the program activation information management unit of the present invention requests it to perform measurement.

FIG. 56A to 56D are schematic diagrams each showing an example of program activation time information according to the present invention.

FIG. 57 is a flow chart indicating a sequence of actions of the program activation information notification unit at the time when the program activation information management unit of the present invention passes it an XAIT and activation history information, and requests it to notify them.

### NUMERICAL REFERENCES

2001 and 3601 Program activation information management units

2002 and 3602 Program activation history information obtainment units

2003 and 3603 Program activation history information update units

2004 and 3604 Program activation time measurement units

2005 and 3605 Program activation information notification units

3606 Program holding management unit

### BEST MODE FOR CARRYING OUT THE INVENTION

Embodiments of the present invention will be described below with reference to the drawings.

### First Embodiment

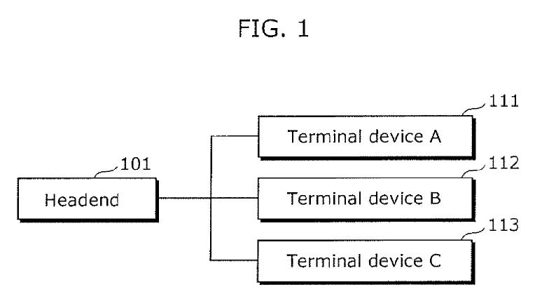

An embodiment of the cable television system according to the present invention will be described with reference to the drawings. FIG. 1 is a block diagram showing the relationship between the constituent devices which make a cable system, and the devices are: a headend 101; and three terminal devices which are a terminal device A111, a terminal device B112 and a terminal device C113. In this embodiment, the three terminal devices are connected to one headend, but the present invention can be implemented even in the case where an arbitrary number of terminal devices are connected to the headend.

The headend 101 transmits, to plural terminal devices, broadcast signals such as video, audio and data, and receives data transmitted from the terminal devices. In order to realize this, a frequency band is divided for use in data transmission between the headend 101, and the terminal device A111, the terminal device B112, and the terminal device C113.

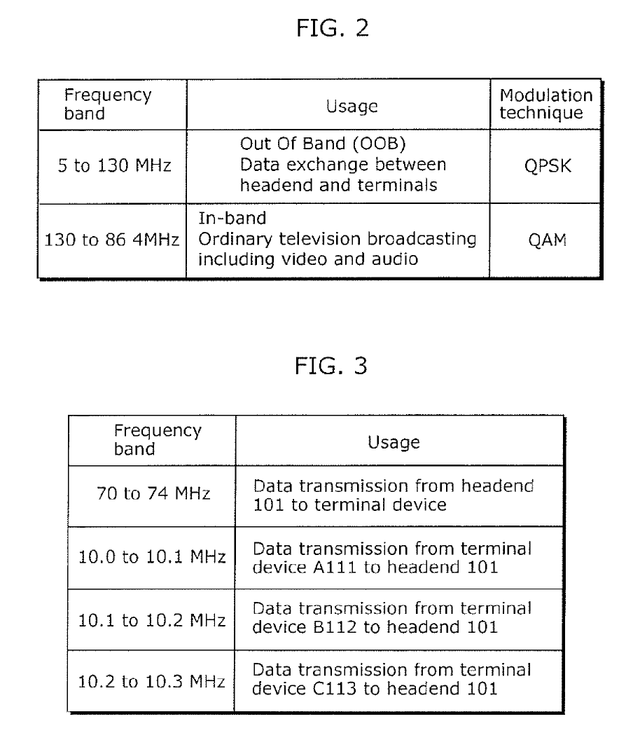

FIG. 2 is a table showing an example of a division of the frequency band. The frequency band is roughly separated into two types of Out Of Band (abbreviated as OOB) and In-Band. As OOB, 5 to 130 MHz is assigned and mainly used for data exchange between the headend 101 and the terminal device A111, the terminal device B112, and the terminal device C113. As In-Band, 130 to 864 MHz is assigned and mainly used by broadcast channels including video and audio. The QPSK modulation scheme is used for OOB, and the QAM64 modulation scheme is used for In-Band. Since techniques relating to modulation schemes are little related to the present invention, detailed descriptions of them are omitted.

FIG. 3 is an example of further detailed use of the OOB frequency band. A frequency band of 70 MHz to 74 MHz is used to transmit data from the headend 101. All of the terminal device A111 the terminal device B112, and the terminal device C113 receive the same data from the headend 101. On the other hand, 10.0 MHz to 10.1 MHz is used to transmit data from the terminal device A111 to the headend 101, 10.1 MHz to 10.2 MHz is used to transmit data from the terminal device B112 to the headend 101, and 10.2 MHz to 10.3 MHz is used to transmit data from the terminal device C113 to the headend 101. Accordingly, data which is unique to each terminal device can be transmitted to the headend 101 from the terminal device A111, the terminal device B112, and the terminal device C113.

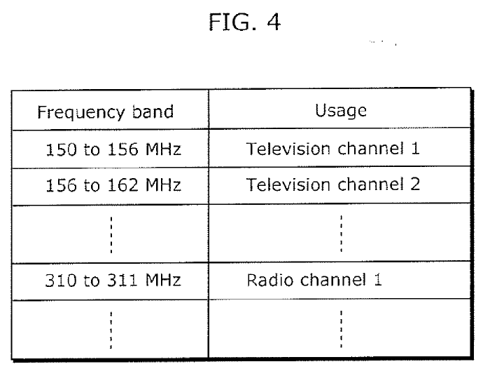

FIG. 4 is an example of use of an In-Band frequency band. Frequency bands of 150 MHz to 156 MHz and 156 MHz to 162 MHz are assigned to a TV channel 1 and a TV channel 2 respectively, and thereafter, TV channels are assigned in 6 MHz intervals. 310 MHz and the subsequent frequencies are allocated to radio channels at 1 MHz intervals. Each of these channels may be used as analog broadcast or as digital broadcast. In the case of digital broadcasting, data is transmitted in a transport packet format based on the MPEG-2 specifications. Data for each kind of data broadcast can be transmitted, in addition to audio and video data.

The headend 101 has a QPSK modulation unit, a QAM modulation unit and the like in order to transmit suitable broadcast signals to the respective frequency bands. In addition, it has a QPSK demodulator for receiving data from the terminal devices. In addition, the headend 101 is assumed to further have various devices related to the above modulation units and demodulation unit. However, detailed descriptions for these are omitted here, since the present invention is mainly related to the terminal devices.

The terminal device A111, the terminal device B112, and the terminal device C113 receive and reproduce broadcast signals transmitted from the headend 101. Furthermore, they transmit data unique to the respective terminal devices to the headend 101. The three terminal devices have the same configuration in this embodiment.

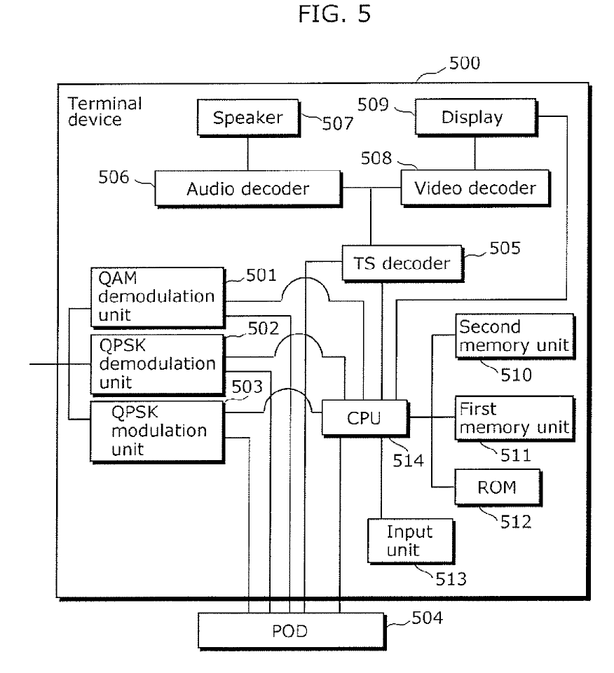

FIG. 5 is a block diagram showing a hardware configuration of each terminal device. A terminal device 500 is configured by: a QAM demodulation unit 501, a QPSK demodulation unit 502, a QPSK modulation unit 503, a TS decoder 505, an audio decoder 506, a speaker 507, a video decoder 508, a display 509, a second memory unit 510, a first memory unit 511, a ROM 512, an input unit 513, and a CPU 514. Additionally, a POD 504 is attachable to/detachable from the terminal device 500.

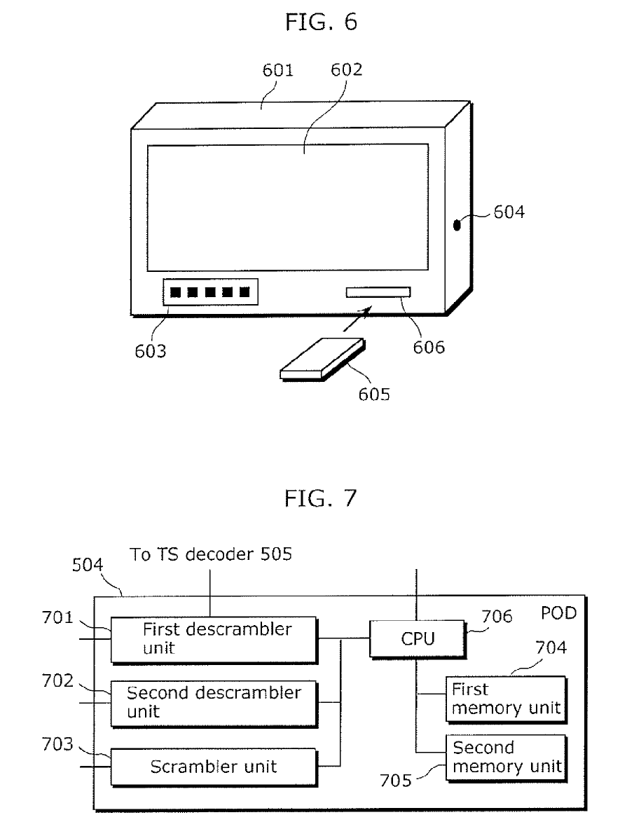

FIG. 6 shows a slim television, which is an example, as an external view, of the terminal device 500. The terminal device can be realized in a variety of configurations, but in the present embodiment, a terminal device which is configured on the basis of OpenCable (trademark) and OCAP is described as an example.

A housing of a slim television 601 contains all constituent elements of the terminal device 500 except for the POD 504.

A display 602 corresponds to the display 509 in FIG. 5.

A front panel unit 603 is made up of plural buttons, and corresponds to an input unit 513 of FIG. 5.

A signal input terminal 604 connects a cable line for transmitting and receiving signals to and from the headend 101. In addition, the signal input terminal 604 is connected to the QAM demodulation unit 501, the QPSK demodulation unit 502 and QPSK modulation unit 503 of FIG. 5.

A POD card 605 corresponds to a POD 504 of FIG. 5. The POD 504 is embodied independently of the terminal device 500 and can be attached to/detached from the terminal device 500, as the POD card 605 of FIG. 6. A detailed description of the POD 504 is provided later.

An insertion slot 606 is an insertion slot to which the POD card 605 is inserted.

Referring to FIG. 5, the QAM demodulation unit 501 demodulates a signal which has been QAM-modulated in the headend 101 and transmitted from the headend 101, according to tuning information including a frequency specified by the CPU 514, and passes the resultant to the POD 504.

The QPSK demodulation unit 502 demodulates a signal which has been QPSK-modulated in the headend 101 and transmitted from the headend 101, according to tuning information including a frequency specified by the CPU 514, and passes the resultant to the POD 504.

The QPSK modulation unit 503 QPSK-demodulates the signal passed from the POD 504 using the demodulation information including the frequency specified by the CPU 514, and transmits it to the headend 101.

As shown in FIG. 6, the POD 504 is attachable to/detachable from the main body of the terminal device 500. A connection interface between the terminal main body 500 and the POD 504 is defined in the OpenCable (trademark), CableCARD (trademark), Interface Specification (OC-SP-CC-IF-I15-031121) and specifications referred to by these specifications. Note that CableCARD of the specifications is a POD. Here, detailed descriptions of these connection interfaces are omitted, and only the parts related to the present invention will be described.

FIG. 7 is a block diagram showing an internal configuration of the POD 504. The POD 504 is configured by: a first descrambler unit 701, a second descrambler unit 702, a scrambler unit 703, a first memory unit 704, a second memory unit 705 and a CPU 706.

The first descrambler unit 701, according to an instruction from the CPU 706, receives a scrambled signal from the QAM demodulation unit 501 of the terminal device 500 and descrambles the signal. Subsequently, the first descrambler unit 701 transmits the descrambled signal to the TS decoder 505 of the terminal device 500. Information required for decoding such as a key is provided by the CPU 706 as necessary. More specifically, the headend 101 broadcasts several pay channels. When the user purchases the right to view these pay channels, the first descrambler unit 701 receives required information such as a key from the CPU 706 and performs descrambling, which allows the user to view these pay channels. In the case where required information such as a key is not provided, the first descrambler unit 701 passes the received signal directly to the TS decoder 505 without performing descrambling.

The second descrambler unit 702, according to an instruction from the CPU 706, receives a scrambled signal from the QPSK demodulation unit 502 of the terminal device 500 and descrambles the signal. Subsequently, the second descrambler unit 702 passes the descrambled data to the CPU 706.

The scrambler unit 703, according to an instruction from the CPU 706, scrambles the data received from the CPU 706 and 6 transmit it to the QPSK modulation unit 503 of the terminal device 500.

More specifically, the first memory unit 704 is configured by a first memory such as a RAM, and the CPU 706 uses the first memory in order to save data when performing processing.

More specifically, the second memory unit 705 is configured by a second memory such as a flash ROM, and it is used for storing a program to be executed by the CPU 706 as well as for holding data which should not be deleted even when the power is turned off.

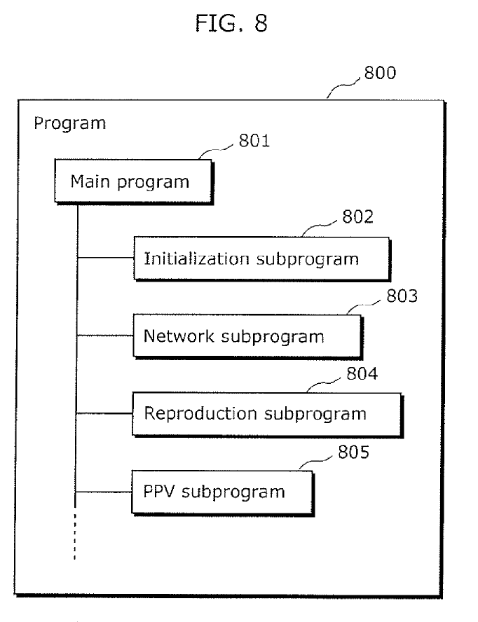

The CPU 706 executes the program recorded in the second memory unit 705. The program is made up of plural subprograms. FIG. 8 shows an example of the program recorded in the second memory unit 705. In FIG. 8, a program 800 is made up of plural subprograms including: a main program 801, an initialization subprogram 802, a network subprogram 803, a reproduction subprogram 804, a PPV subprogram 805 and the like.

Here, PPV, which is an abbreviation of Pay Per View, refers to a service that allows the user to view a certain program such as a movie, on a charge basis. When the user enters his or her personal identification number, the purchase of the right to view the program is notified to the headend 101, scrambling is canceled, and the program can be viewed by the user. With this viewing, the user is required to pay the purchase charge at a later date.

The main program 801, which is the subprogram activated first by the CPU 706 when the power is turned on, controls the other subprograms.

The initialization subprogram 802, which is activated by the main program 801 when the power is turned on, performs information exchange with the terminal device 500 and performs initialization. Details of the initialization processing are defined in OpenCable (trademark), CableCARD (trademark), Interface Specification (OC-SP-CC-IF-I15-031121) and the specifications referred to by these specifications. Furthermore, the initialization subprogram 802 also performs initialization processing which is not defined in these specifications. Here, a part of such initialization processing is introduced. When the power is turned on, the initialization subprogram 802 notifies the QPSK demodulation unit 502 of a first frequency recorded in the second memory unit 705 via the CPU 514 of the terminal device 500.

The QPSK demodulation unit 502 performs tuning using the provided first frequency, and transmits the resulting signal to the second scrambler unit 702. Moreover, the initialization subprogram 802 provides the second descrambler unit 702 with descrambling information such as a first key recorded in the second memory unit 705. As a result, the second descrambler unit 702 performs descrambling and passes the resultant to the CPU 706 which executes the initialization subprogram 802. As such, the initialization subprogram 802 can receive the information. In the present embodiment, the initialization subprogram 802 receives information via the network subprogram 803. A detailed description on this is provided later.

In addition, the initialization subprogram 802 notifies the QPSK modulation unit 503 of a second frequency recorded in the second memory unit 705 via the CPU 514 of the terminal device 500. The initialization subprogram 802 provides the scrambler unit 703 with the scrambling information recorded in the second memory unit 705. When the initialization subprogram 802 provides, via the network subprogram 803, the scrambler unit 703 with information which is desired to be transmitted, the scrambler unit 703 scrambles the data using the provided scrambling information, and provides the QPSK modulation unit 503 with the scrambled data. The QPSK modulation unit 503 modulates the scrambled information which has been provided, and transmits the modulated information to the headend 101.

As a result, it becomes possible for the initialization subprogram 802 to carry out an interactive communication with the headend 101 via the terminal device 500, the second descrambler unit 702, the scrambler unit 703, and the network subprogram 803.

The network subprogram 803, which is used by plural subprograms such as the main program 801 and the initialization subprogram 802, is a subprogram intended for carrying out an interactive communication with the headend 101. More specifically, the network subprogram 803 behaves as if other subprograms using the network subprogram 803 were carrying out an interactive communication with the headend 101 in accordance with TCP/IP. A detailed explanation of TCP/IP is omitted here, since it is a commonly known technique for prescribing the protocols to be used when plural terminals exchange information with each other. When activated by the initialization subprogram 802 at the power-on time, the network subprogram 803 notifies, via the terminal device 500, the headend 101 of a Media Access Control (abbreviated as MAC address which is an identifier for identifying the POD 504 and which is recorded in the second memory unit 705 in advance, and requests for the obtainment of an IP address. The headend 101 notifies the POD 504 of the IP address via the terminal device 500, and the network subprogram 803 records the IP address in the first memory unit 704. Hereinafter, the headend 101 and the POD 504 carries out communication using this IP address as the identifier of the POD 504.

The reproduction subprogram 804 provides the first descrambler unit 701 with descrambling information such as a second key recorded in the second memory unit 705 as well as descrambling information such as a third key provided by the terminal device 500, so as to enable descrambling. Furthermore, the reproduction subprogram 804 receives, via the network subprogram 803, information indicating that the signal inputted in the first descrambler unit 701 is a PPV channel. On the notification that the signal is a PPV channel, the reproduction subprogram 804 activates the PPV subprogram 805.

When activated, the PPV subprogram 805 displays, on the terminal device 500, a message that prompts the user to purchase the program, and receives an input from the user. More specifically, when information which is desired to be displayed on the display screen is transmitted to the CPU 514 of the terminal device 500, a program which runs on the CPU 514 of the terminal device 500 displays the message on the display 509 of the terminal device 500. When the user inputs a personal identification number through the input unit 513 of the terminal device 500, the CPU 514 of the terminal device 500 receives it and notifies the PPV subprogram 805 which runs on the CPU 706 of the self POD 504. The PPV subprogram 805 transmits, to the headend 101, the accepted personal identification number via the network subprogram 803. When the personal identification number is correct, the headend 101 notifies, via the network subprogram 803, the PPV subprogram 805 of descrambling information such as a fourth key which is required for descrambling.

The PPV subprogram 805 provides the first descrambler unit 701 with the received descrambling information such as the fourth key, and then the first descrambler unit 701 descrambles the signal which is being inputted.

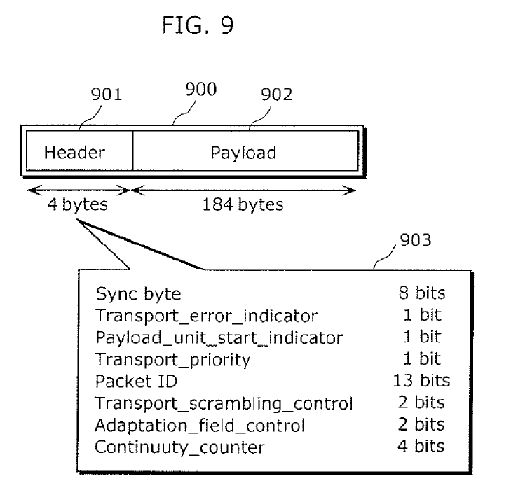

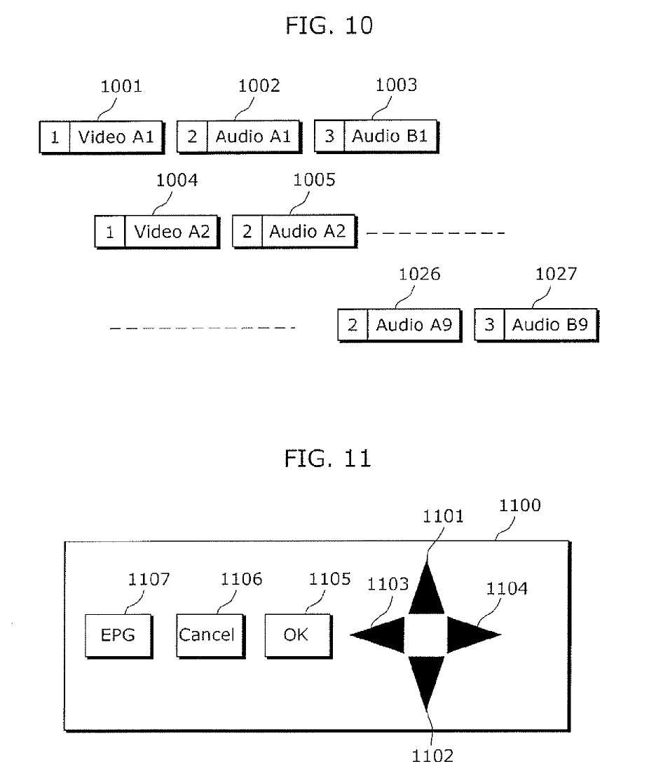

Referring to FIG. 5, the TS decoder 505 performs filtering on the signal received from the POD 504, and passes necessary data to the audio decoder 506, the video decoder 508, and the CPU 514. Here, the signal transmitted from the POD 504 is an MPEG-2 transport stream. An MPEG-2 transport stream is described in detail in the MPEG specifications ISO/IEC13818-1, and therefore it is not described in detail in the present embodiment. An MPEG-2 transport stream is composed of plural fixed-length packets, and a packet ID is assigned to each packet. FIG. 9 is a diagram showing the structure of a packet. 900 is a packet having a fixed length of 188 bytes. The top four bytes is a header 901 storing identification information of the packet, and the remaining 184 bytes is the payload 902 containing the information which is desired to be transmitted. 903 shows the contents of the header 901. A packet ID is included in the 13 bits of the twelfth to twenty-fourth bits from the top. FIG. 10 is a schematic diagram illustrating plural packet strings to be transmitted. A packet 1001 carries a packet ID “1” in its header and includes the first information of video A in its payload. A packet 1002 carries a packet ID “2” in its header and includes the first information of audio A in its payload. A packet 1003 carries a packet ID “3” in its header and includes the first information of audio B in its payload.

A packet 1004 carries the packet ID “1” in its header and includes the second information of the video A in its payload, and is the continuation of the packet 1001. Similarly, packets 1005, 1026, and 1027 carry follow-on data of the other packets. Connecting the contents of the payloads of packets with the same packet ID in this way makes it possible to reproduce a continuous video and audio.

Referring to FIG. 10, when the CPU 514 indicates, to the TS decoder 505, the packet ID “1” as well as “the video decoder 508” which is an output destination, the TS decoder 505 extracts packets with the packet ID “1” from the MPEG-2 transport stream received from the POD 504, and passes them to the video decoder 508. In FIG. 10, only the video data is passed over to the video decoder 508. In parallel, when the CPU 514 indicates, to the TS decoder 505, the packet ID “2” as well as “the audio decoder 506”, the TS decoder 505 extracts packets with the packet ID “2” from the MPEG-2 transport stream received from the POD 504, and passes them to the audio decoder 506. In FIG. 10, only the audio data is passed over to the video decoder 508.

This process of extracting only necessary packets according to the packet ID is the filtering performed by the TS decoder 505. The TS decoder 505 is capable of performing, in parallel, more than one filtering processing specified by the CPU 514.

Referring to FIG. 5, the audio decoder 506 connects audio data embedded in the packets of the MPEG-2 transport stream provided by the TS decoder 505, performs digital-to-analog conversion on the connected data, and outputs the resultant to the speaker 507.

The speaker 507 outputs, as audio, the signal provided by the audio decoder 506.

The video decoder 508 connects video data embedded in the packets of the MPEG-2 transport stream provided by the TS decoder 505, performs digital-to-analog conversion on the connected data, and outputs the resultant to the display 509.

More specifically, the display 509 is configured by a cathode-ray tube or a liquid crystal and the like, outputs a video signal provided by the video decoder 508 and displays a message specified by the CPU 514, and so forth.

More specifically, the second memory unit 510 is made up of a flash memory, a hard disk or the like, holds and deletes data and programs specified by the CPU 514. Furthermore, the held data and programs are referred to by the CPU 514. The held data and programs are kept in storage even when the power to the terminal device 500 is cut off.

More specifically, the first memory unit 511 is made up of a RAM or the like, temporarily saves and deletes data and programs specified by the CPU 514. Furthermore, the held data and programs are referred to by the CPU 514. The held data and programs are deleted when the power to the terminal device 500 is cut off.

More specifically, the ROM 512 is a read-only memory device and is made up of a ROM, a CD-RON, a DVD, or the like. In the ROM 512, a program to be executed by the CPU 514 is stored.

More specifically, the input unit 513 is configured by a front panel, a remote control and the like, and receives an input from the user. FIG. 11 is an example of the input unit 513 which is configured as a front panel. 1100 is a front panel and corresponds to the front panel unit 603 of FIG. 6. The front panel 1100 includes seven buttons: an up cursor button 1101, a down cursor button 1102, a left cursor button 1103, a right cursor button 1104, an OK button 1105, a cancellation button 1106 and an EPG button 1107. When the user presses down a button, the identifier of such pressed button is notified to the CPU 514.

The CPU 514 executes the program recorded in the ROM 512. According to the instruction of the program to be executed, it controls the QAM demodulation unit 501, the QPSK demodulation unit 502, the QPSK modulation unit 503, the POD 504, the TS decoder 505, the display 509, the second memory unit 510, the first memory unit 511 and the ROM 512.

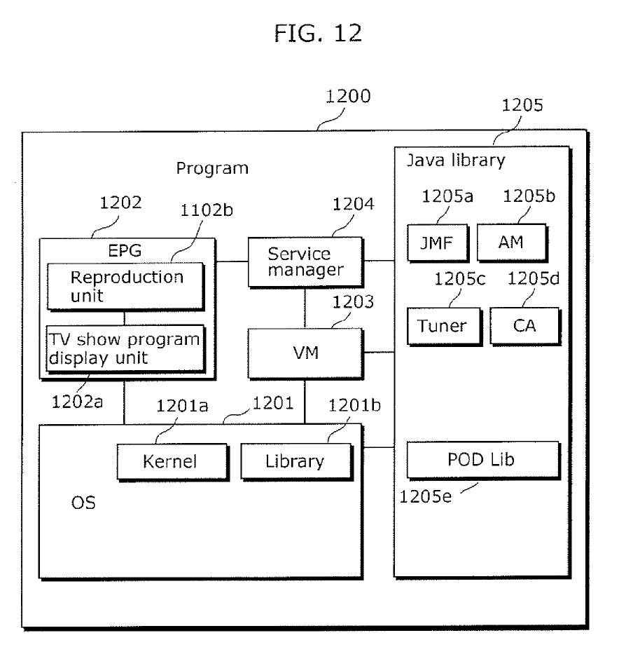

FIG. 12 is an example of a configuration diagram of the program which is recorded in the ROM 512 and to be executed by the CPU 514.

The program 1200 is made up of plural subprograms, to be more specific, an OS 1201, an EPG 1202, a Java (trademark) VM 1203 (hereinafter referred to as VM 1203), a service manager 1204 and a Java library 1205 (hereinafter referred to as library 1205).

The OS 1201 is a subprogram activated by the CPU 514 when power to the terminal device 500 is turned on. The OS 1201 stands for operating system, and an example of which is Linux. The OS 1201 is a generic name for commonly known technique made up of a kernel 1201a for executing a subprogram in parallel with another subprogram and of a library 1201b, and therefore a detailed description is omitted. In this embodiment, the kernel 1201a of the OS 1201 executes the EPG 1202 and the VM 1203 as subprograms. Meanwhile, the library 1201b provides these subprograms with plural functions required for controlling the constituent elements of the terminal device 500.

A tuning function can be introduced as an example of these functions. With the tuning function, tuning information including a frequency is received from another subprogram and then passed over to the QAM demodulation unit 501. Accordingly, it is possible for the QAM demodulation unit 501 to perform demodulation processing based on the provided tuning information, and pass the demodulated data to the POD 504. As a result, the other subprograms can control the QAM demodulator via the library 1201b.

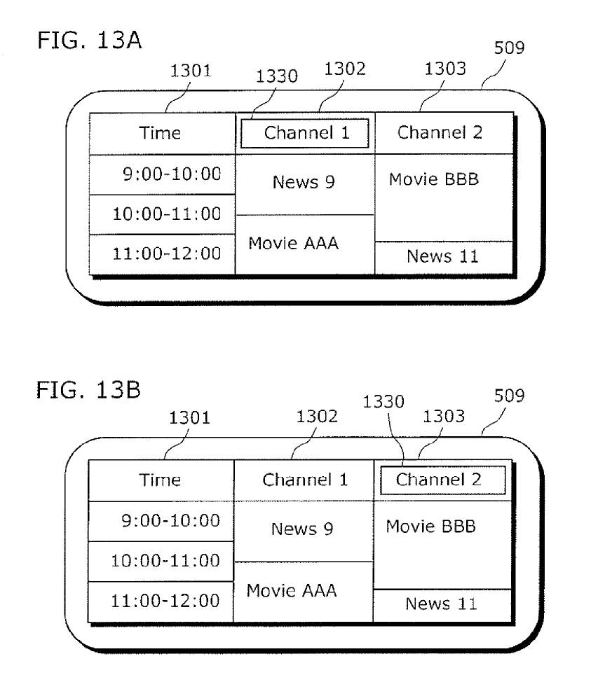

The EPG 1202 is configured by: a TV show program display unit 1202a, which displays a TV show program list to a user and receives an input from the user; and a reproduction unit 1202b which carries out channel selection. Here, EPG is an abbreviation of Electric Program Guide. The EPG 1202 is activated by the kernel 1201a when power to the terminal device 500 is turned on. Inside the activated EPG 1202, the program display unit 1202a waits input from the user through the input unit 513 of the terminal device 500. Here, in the case where the input unit 513 is configured as the front panel shown in FIG. 11, when the user presses down the EPG button 1107 on the input unit 513, the identifier of the EPG button is notified to the CPU 514. The TV show program display unit 1202a of the EPG 1202, which is a subprogram which runs on the CPU 514, receives this identifier and displays information of the TV shown program on the display 509. FIG. 13A and FIG. 13B are each an example of a TV show program guide displayed on the display 509. Referring to FIG. 13A, the TV show program information is displayed on the display 509 in a grid pattern. Time information is displayed in a column 1301. A channel name “channel 1” and a TV show program shown during a time period corresponding to the time in the column 1301 is displayed in the column 1301. It shows that, through “channel 1”, a TV show program “News 9” is broadcast at 9:00 to 10:30, and “Movie AAA” is broadcast at 10:30 to 12:00. A channel name “channel 2” and a TV show program which is to be broadcast during a time period corresponding to the time in the column 1301 is displayed in the column 1303 similarly to the column 1302. A TV show program “Movie AAA” is broadcast at 9:00 to 11:00, and “News 11” is broadcast at 11:00 to 12:00. 1330 is a cursor. The cursor 1330 moves at the press of the left cursor 1103 and the right cursor 1104 on the front panel 1100. When the right cursor 1104 is pressed down in the state illustrated in FIG. 13A, the cursor 1330 moves towards the right as shown in FIG. 13B. Meanwhile, when the left cursor 1103 is pressed down in the state illustrated in FIG. 13B, the cursor 1330 moves towards the left as shown in FIG. 13A.

When the OK button 1105 on the front panel 1100 is pressed down in the state shown in FIG. 13A, the TV show program display unit 1202a notifies the reproduction unit 1202b of the identifier of “Channel 1”. When the OK button 1105 on the front panel 1100 is pressed down in the state shown in FIG. 13B, the TV show program display unit 1202a notifies the reproduction unit 1202b of the identifier of “Channel 2”.

Furthermore, the TV show program display unit 1202a periodically records TV show program information to be displayed from the headend 101 into the first memory unit 511 via the POD 504. Generally, it takes time to obtain TV show program information from the headend. However, it becomes possible to quickly display a TV show program guide by displaying the TV show program information which has been stored in advance in the first memory unit 511 when the EPG button 1107 of the input unit 513 is pressed down.

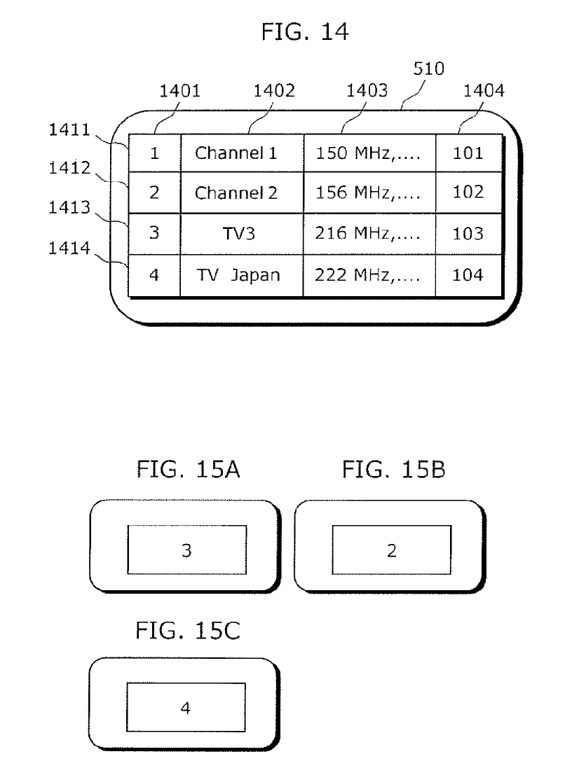

The reproduction unit 1202b reproduces the channel using the received channel identifier. The respective relationship between channels and the identifiers of the channels have been stored in advance in the second memory unit 510 as channel o information. FIG. 14 is an example of the channel information stored in the second memory unit 510. The channel information is stored in tabular format. A column 1401 describes the identifiers of channels. A column 1402 describes the channel names of the channels. A column 1403 describes the tuning information of the channels. Here, the tuning information is represented by values to be provided to the QAM demodulation unit 501 and includes frequency, transmission rate, and coding rate. A column 1404 describes the program numbers of the channels. Program numbers are numbers used for identifying a PMT prescribed by the MPEG-2 specifications. A description of the PMT is provided later. Each of the columns 1411 to 1414 indicates a set of the identifier of a channel, the channel name, and the tuning information. The column 1411 describes a set including the identifier of “1” of a channel, the channel name of “Channel 1” , the frequency of “312 MHz” as tuning information, and the program number of “101” . The reproduction unit 1202b passes the received channel identifier directly to the service manager in order to reproduce the channel.

Moreover, when the user presses down the up cursor 1101 and the down cursor 1102 on the front panel 1100 while reproduction is performed, the reproduction unit 1202b receives a notification about the press by the user from the input unit 513 via the CPU 514, and switches the channel which is being reproduced to another one. First, the reproduction unit 1202b stores, in the first memory unit 511, the identifier of the channel which is currently being reproduced. FIGS. 15A, 15B and 15C are examples of channel identifiers held in the first memory unit 511. In FIG. 15A, a channel identifier “3” is stored, and by referring to FIG. 14, it is indicated that the channel with a channel name of “TV 3” is being reproduced. When the user presses down the up-cursor 1101 in the state illustrated in FIG. 15A, the reproduction unit 1202b refers to the channel information shown in FIG. 14, and passes the identifier “2” of the channel name of “Channel 2” to the service manager in order to switch reproduction to the channel with the channel name of “Channel 2”, which is the previous channel in the guide. In parallel, the reproduction unit 1202b rewrites the identifier to the channel identifier “2” recorded in the first memory unit 511. FIG. 15C shows the state in which the channel identifier has been rewritten. Meanwhile, when the user presses down the down cursor 1102 in the state illustrated in FIG. 15A, the reproduction unit 1202b refers to the channel information shown in FIG. 14, and passes the identifier “4” of the channel name of “TV Japan” to the service manager in order to switch reproduction to the channel with the channel name of “TV Japan”, which is the next channel in the guide. In parallel, the reproduction unit 1202b rewrites the identifier to the channel identifier “4” recorded in the first memory unit 511. FIG. 15C shows the state in which the channel identifier has been rewritten.

The Java VM 1203 is a Java (trademark) Virtual Machine which sequentially analyzes and executes programs written in Java language. Programs written in Java (trademark) language are compiled of intermediate codes called bytecodes which do not depend on the hardware. The Java (trademark) virtual machine is an interpreter which executes this bytecodes. Some of the Java (trademark) virtual machines translate the bytecodes into an executable form which can be interpreted by the CPU 514 and pass the resultant to the CPU 514 which executes them. When the kernel 1201a specifies a Java (trademark) program to be executed, the VM 1203 is activated. In this embodiment, the kernel 1201a specifies a service manager 1204 as the Java (trademark) program to be executed. Details of the Java (trademark) language are described in many books such as “Java Language Specification (ISBNO-201-63451-1)”. Here, those details are omitted. In addition, detailed actions of the Java (trademark) VM itself are described in many books such as “Java Virtual Machine Specification (ISBNO-201-63451-X)”. Here, those details are omitted.

The service manager 1204 is a Java (trademark) program written in Java language, and is executed sequentially by the VM 1203. The service manager 1204 is capable of calling other subprograms which are not written in Java language or being called via a Java Native Interface (JNI). JNI is also described in many books such as “Java (trademark) Native Interface.” Here, those details are omitted.

The service manager 1204 receives the channel identifier from the reproduction unit 1202b via the JNI.

The service manager 1204 passes the channel identifier to a tuner 1205c in the Java library 1205 first, and then requests for tuning. The tuner 1205c refers to the channel information recorded in the second memory unit 510, and obtains the tuning information. It is assumed now that the service manager 1204 passes over the channel identifier of “2” to the tuner 1205c. The tuner 1205c obtains the tuning information of “156 MHz” corresponding to the channel identifier of “2” with reference to the column 1412 of FIG. 14. The tuner 1205c passes over the tuning information to the QAM demodulation unit 501 via the library 1201b of the OS 1201. The QAM demodulation unit 501 demodulates the signal transmitted from the headend 101 according to the provided tuning information, and passes over the resultant signal to the POD 504.

Next, the service manager 1204 requests the CA 1205d inside the library 1205 for descrambling. The CA 1205d provides the POD 504 with information necessary for descrambling via the library 1201b of the OS 1201. On the basis of the provided information, the POD 504 descrambles the signal provided by the QAM demodulation unit 501, and passes over the resultant signal to the TS decoder 505.

Next, the service manager 1204 provides a JMF 1205a inside the Java library 1205 with the channel identifier and requests for reproduction of the video and audio.

First, the JMF 1205a obtains, from a PAT and a PMT, packet IDs used for specifying the video and audio to be reproduced. A PAT and a PMT are tables prescribed by the MPEG-2 specifications which show the TV show program line-up included in an MPEG-2 transport stream. Such PAT and PMT are embedded in the payloads of packets included in the MPEG-2 transport stream and transmitted together with audio and video packets. Refer to the specifications for a detailed description of the PAT and PMT. Here, only an overview of the PAT and PMT is provided.

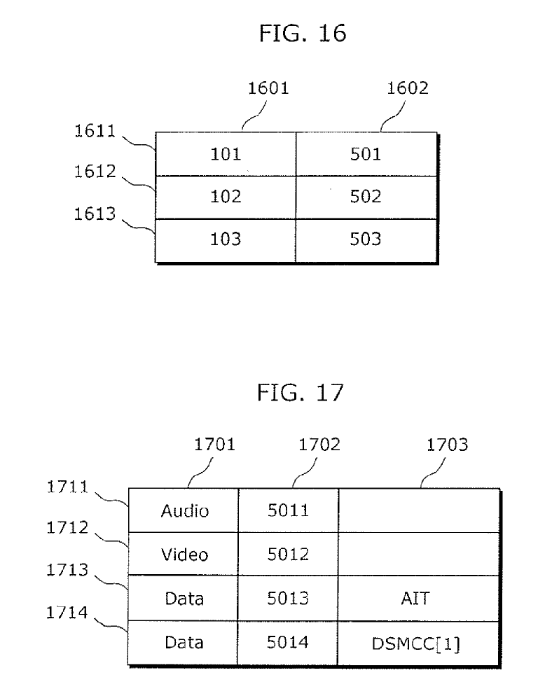

PAT is an abbreviation of Program Association Table. It is stored in packets having a packet ID of “0”, and transmitted. In order to obtain a PAT, the JMF 1205a specifies the packet ID of “0” and the CPU 514 to the TS decoder 505 via the library 1201b of the OS 1201. The TS decoder 505 performs filtering using the packet ID of “0” and passes over the obtained packets to the CPU 514. By doing this, the JMF 1205a collects the packets of the PAT. FIG. 16 is a table which schematically shows an example of information of the collected PAT. A column 1601 prescribes program numbers. A column 1602 prescribes the packet IDs. These packet IDs shown in the column 1602 are used for obtaining a PMT. Each of the lines 1611 to 1613 is a pair of the program number of a channel and the packet ID corresponding to the program number. Here, three channels are defined. The line 1611 defines a pair of the program number “101” and the packet ID “501”. It is assumed now that the channel identifier provided to the JMF 1205a is “2”. The JMF 1205a obtains the program number of “102” corresponding to the channel identifier with reference to the line 1412 of FIG. 14, and then obtains the packet ID of “502” corresponding to the program number “102” with reference to the line 1612 of FIG. 16. PMT is an abbreviation of Program Map Table. It is stored in the packets having a packet ID which is prescribed in a PAT and transmitted. In order to obtain such PMT, the JMF 1205a specifies a packet ID and the CPU 514 to the TS decoder 505 via the library 1201b of the OS 1201. Here, a packet ID to be specified is “502”. The TS decoder 505 performs filtering using the packet ID of “502” and passes over the obtained packets to the CPU 514. By doing this, the JMF 1205a collects the packets of the PAT.

FIG. 17 is a table which schematically shows an example of information of the collected PMT. A column 1701 describes stream types. A column 1702 describes the packet IDs. Information specified by the respective stream types is stored in the payloads of the packets with the packet IDs specified in the column 1702. A column 1703 describes the supplemental information. Each of lines 1711 to 1714 is a pair of a packet ID and the type of information which is being transmitted and called elementary stream. The line 1711, which is a pair of the stream type “audio” and the packet ID “5011”, indicates that audio data is stored in the payloads of the packets with the packet ID “5011”. The JMF 1205a obtains, from the PMT, the packet IDs of the video and audio to be reproduced. Referring to FIG. 17, the JMF 1205a obtains an audio packet ID of “5011” from the line 1711 and a video packet ID of “5012” from the line 1712.

Next, the JMF 1205a provides the TS decoder 505 with pairs of the obtained audio packet ID and the audio decoder 506 which is an output destination as well as the video packet ID and the video decoder 508 which is an output destination, via the library 1201b of the OS 1201. The TS decoder 505 performs filtering based on the provided packet IDs and the output destinations. Here, the packet with the packet ID “5011” is passed to the audio decoder 506 and the packet with the packet ID “5012” is passed to the video decoder 508. The audio decoder 506 performs digital-to-analog conversion on the provided packet, and reproduces the audio via the speaker 507. The video decoder 508 performs digital-to-analog conversion on the provided packet, and displays the video on the display 509.

Finally, the service manager 1204 provides the channel identifier to an AM 1205b in the Java library 1205, and requests for data broadcast reproduction. Here, data broadcast reproduction means extracting a Java (trademark) program included in the MPEG-2 transport stream and causing the VM 1203 to execute the program. As a method for embedding the Java (trademark) program into the MPEG-2 transport stream, a method called DSMCC described in the MPEG specifications ISO/IEC138181-6 is used. Here, a detailed description of the DSMCC is omitted. The DSMCC method defines a method of encoding a file system comprised of directories, files and the like used by a computer, in packets within an MPEG-2 transport stream. In addition, the information of the Java (trademark) program to be executed is embedded, in a form of so-called AIT, in a packet of the MPEG-2 transport stream. The AIT is an abbreviation of Application Information Table defined in the Chapter 10 of the DVB-MHP specifications.

The AM 1205b obtains a PAT and a PMT first, similarly to the JMF 1205a, in order to acquire an AIT, and then acquires the packet ID of the packet where the AIT is stored. Assuming now that the identifier of the given channel is “2” and the PAT of FIG. 16 and the PMT of FIG. 17 are being transmitted, it acquires the PMT of FIG. 17 in a similar procedure to one taken by the JMF 1205a. The AM 1205b extracts, from the PMT, the packet ID of the elementary stream whose stream type is “Data” and which has “AIT” as supplemental information. The elementary stream in the line 1713 corresponds to such elementary stream, and therefore the AM 1205b acquires the packet ID “5013” with reference to FIG. 17.

The AM 1205b provides the packet ID of the AIT and the CPU 514 which is the output destination to the TS decoder 505 through the library 1201b of the OS 1201. The TS decoder 505 then performs filtering based on the provided packet ID, and passes the resultant to the CPU 514. Accordingly, the AM 1205b can collect the packets of the AIT.

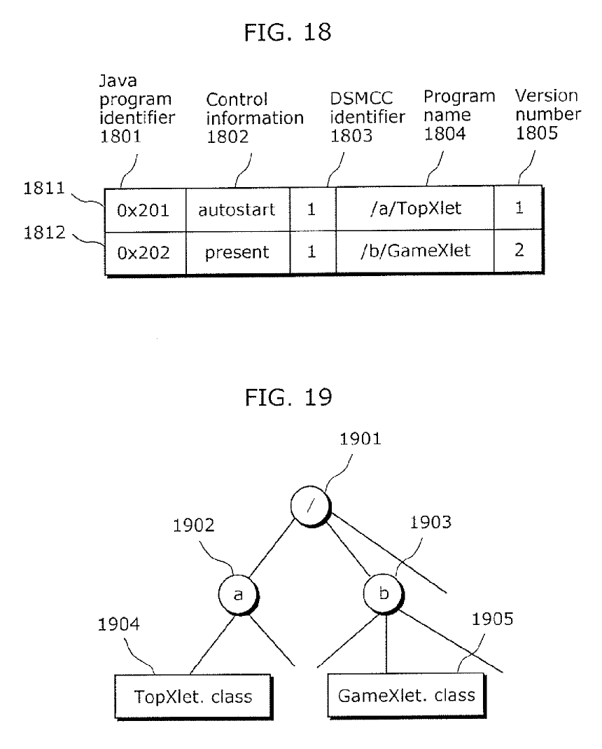

FIG. 18 is a table which schematically shows an example of information of the collected AIT. A column 1801 is the identifier of a Java (trademark) program. According to the MHP specifications, this identifier is defined as Application ID. A column 1802 is control information for the Java (trademark) program. Such control information includes “autostart”, “present” and “kill”. More specifically, “autostart” means that the terminal device 500 automatically executes this program immediately, “present” means that it does not automatically execute this program, and “kill” means that it stops this program. A column 1803 is a DSMCC identifier for extracting the ID of the packet including the Java (trademark) program written in DSMCC format. A column 1804 is the program name of the Java (trademark) program. A column 1805 is the version number of the Java (trademark) program.

Lines 1811 and 1812 are a set of information of the Java (trademark) program. The Java (trademark) program defined by the line 1811 is a set of the identifier “0x201”, the control information “autostart”, the DSMCC identifier “1”, the program name “a/TopXlet”, and the version number “1”. The Java (trademark) program defined by the line 1812 is a set of the identifier “0x202”, the control Information “present”, the DSMCC identifier “1”, the program name “b/GameXlet”, and the version number “2”. Here, the two Java (trademark) programs have the same DSMCC identifier. This indicates that two Java programs are included in one file system encoded in DSMCC format.

Here, only five items of information are specified for the respective Java (trademark) programs, but more items of information are specified in actuality. Refer to the DVB-MHP specifications for detail.

AM 1205b detects the Java (trademark) program of “autostart” in an AIT, and extracts the DSMCC identifier and the Java (trademark) program name which are associated with the Java program. With reference to FIG. 18, the AM 1205b extracts the Java (trademark) program of the line 1811, and acquires the DSMCC identifier “1” and the Java program name “a/TopXlet”. Here, it is assumed that the AIT information of the line 1811 is called activation AIT information.

Next, the AM 1205b acquires the packet ID of the packet which stores the Java (trademark) program in DSMCC format using the DSMCC identifier obtained from the AIT. More specifically, the AM 1205b obtains, from the PMT, the packet ID included in the elementary stream having the stream type of “Data” and a matching DSMCC identifier in the supplemental information.

Assuming now that such DSMCC identifier is “1” and the PMT is the one shown as FIG. 17, the elementary stream in the line 1714 matches. Therefore, the packet ID of “5014” is to be extracted.

The AM 1205b specifies the packet ID of the packet into which the TS decoder 505 embedded data in DSMCC format through the library 1201b of the OS 1201 and the CPU 514 which is the output destination. Here, the packet ID “5014” is provided. The TS decoder 505 then performs filtering based on the provided packet ID, and passes the resultant to the CPU 514. Accordingly, the AM 1205b can collect the required packets. The AM 1205b reconstructs the file system from the collected packets according to the DSMCC method, and stores the reconstructed file system into the first memory unit 511. The process for extracting data such as the file system from packets in the MPEG-2 transport stream and storing the extracted data into memory units such as the first memory unit 511 is hereinafter called download.

FIG. 19 is an example of a downloaded file system. In this figure, circles and squares respectively shows directories and files, 1901 is a route directory, 1902 is a directory “a”, 1903 is a directory “b” and 1904 is a file “TopXlet. class”, and 1905 is a file “GameXlet. class”.

Next, the AM 1205b passes, to the VM 1203, the Java (trademark) program in the file system downloaded to the first memory unit 511. Assuming now that the name of the Java (trademark) program to be executed is “a/TopXlet”, the file to be executed is the file “a/TopXlet. class” with “. class” added to the end of the Java program name. “/” is a delimiter between directory names or between file names, and referring to FIG. 19, a file 1904 is the Java (trademark) program which should be executed. Next, the AM 1205b passes the file 1904 to the VM 1203.

The VM 1203 executes the passed Java (trademark) program.

Upon the receipt of the identifier of another channel, the service manager 1204 terminates the reproduction of the video and audio which are being reproduced as well as the execution of the Java (trademark) program which are being carried out through each library included in the Java library 1205, through each library which is also included in the same Java library 1205, and then performs the reproduction of the video and audio as well as the execution of the Java program based on the newly received channel identifier.

The library 1205 is an assembly of Java (trademark) libraries stored in the RON 512. In this embodiment, here, the library 1205 includes a JMF 1205a, an AM 1205b, a tuner 1205c, a CA 1205d and a PODLib 1205e.

A function which will be described next is the function of obtaining history of a time and information related to download and activation of a Java (trademark) program which is the function of the present invention, and notifying a user of the history information.

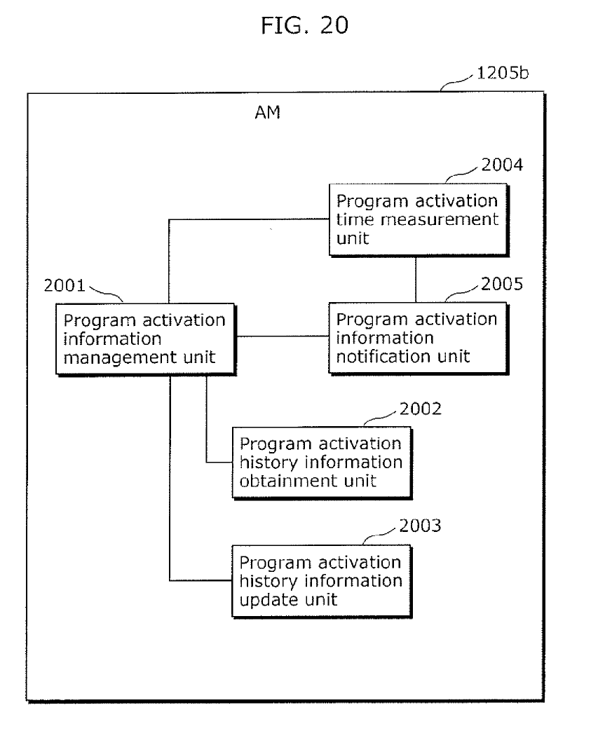

FIG. 20 is a block diagram showing only constituent elements of the AM 1205b at the time of executing the function of obtaining a time and information related to download and activation of the Java (trademark) program based on the activation AIT information collected by the AM 1205b, and notifying the user of the history information. The other constituent elements are omitted because they are not directly related to the present invention.

As shown in FIG. 20, the AM 1205b includes: a program activation information management unit 2001, a program activation history information obtainment unit 2002, a program activation history information update unit 2003, a program activation time measurement unit 2004 and a program activation information notification unit 2005.

Based on the activation AIT information collected by the AM 1205b, the program activation information management unit 2001 makes: a request for obtaining activation history information of the Java (trademark) program; a request for notifying the activation history information and the like of the Java program; and a request for measuring the time needed for downloading and activating the Java program. In addition, it obtains the measurement result of the download and activation time of the Java (trademark) program and makes a request for updating the activation history information of the Java program.

The program activation history information obtainment unit 2002 obtains history information of the Java (trademark) program which has been downloaded and activated, based on the request by the program activation information management unit 2001.

The program activation history information update unit 2003 updates the history information of the Java (trademark) program, based on the request by the program activation information management unit 2001.

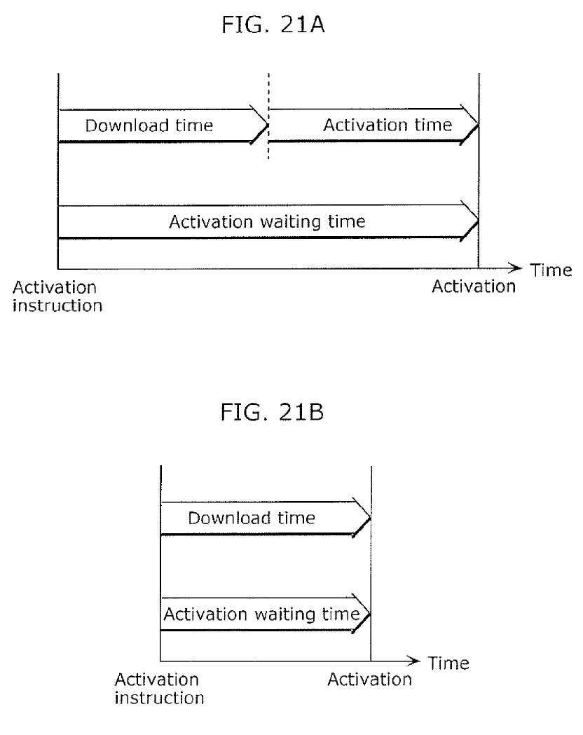

The program activation time measurement unit 2004 measures a download and activation time of the Java (trademark) program, based on the request by the program activation information management unit 2001. In other words, a total of this time needed for download (download time) and time needed for activation (activation time) is an activation waiting time; that is, the time from the reception of an activation instruction for activating a program to the actual activation of the program, as shown in FIG. 21A. Here, the activation time of a program is the time from the completion of downloading the program to the activation of the downloaded program, and includes a time for preprocessing such as initialization of the program. In addition, the download time of a program is the time from when an activation instruction for activating the program is received to when the download of the program is completed, and includes the time for authentication and the time when an activation instruction for activating the program is received to when the download of the program is started.

The program activation information notification unit 2005 notifies the history information of the Java (trademark) program, based on the request by the program activation information management unit 2001.

Firstly described actions are: requesting for obtaining activation history information of the Java (trademark) program, notifying activation history information and the like, and measuring a time needed for download and activation of the program.

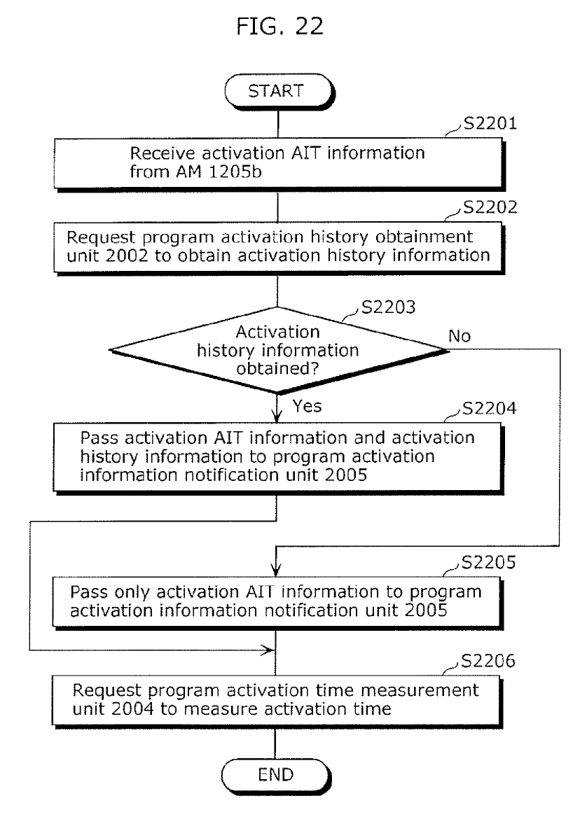

FIG. 22 is a flow chart indicating a sequence of the actions of the program activation information management unit 2001. The actions are: requesting for obtaining activation history information of the Java (trademark) program, notifying activation history information and the like, and measuring a time needed for download and activation of the program. At the time when the AM 1205b completes collection of activation AIT information, the program activation information management unit 2001 receives, from the AM 1205b, the activation AIT information collected by the AM 1205b (Step 2201). The program activation information management unit 2001 passes the received AIT information to the program activation history information obtainment unit 2002, and is requests it to obtain the activation history information of the Java (trademark) program (Step 2202). The program activation information management unit 2001 judges whether the activation history information is obtained (Step 2203) as the result of the obtainment request made in Step 2202. In the case where the judgment result of the obtainment request shows that it is obtained (Yes in Step 2203), the program activation information management unit 2001 passes the activation AIT information and the obtained activation history information to the program activation information notification unit 2005, and requests it to notify them (Step 2204). The program activation information management unit 2001 judges whether the activation history information is obtained (Step 2203) as the result of the obtainment request made in Step 2202. In the case where the judgment result of the obtainment request shows that it is not obtained (No in Step 2203), the program activation information management unit 2001 passes the activation AIT information to the program activation information notification unit 2005, and requests it to notify the activation AIT information (Step 2205). Lastly, the program activation information management unit 2001 passes the program activation time measurement unit 2004 the activation AIT information, and requests it to measure the activation time (Step 2206).

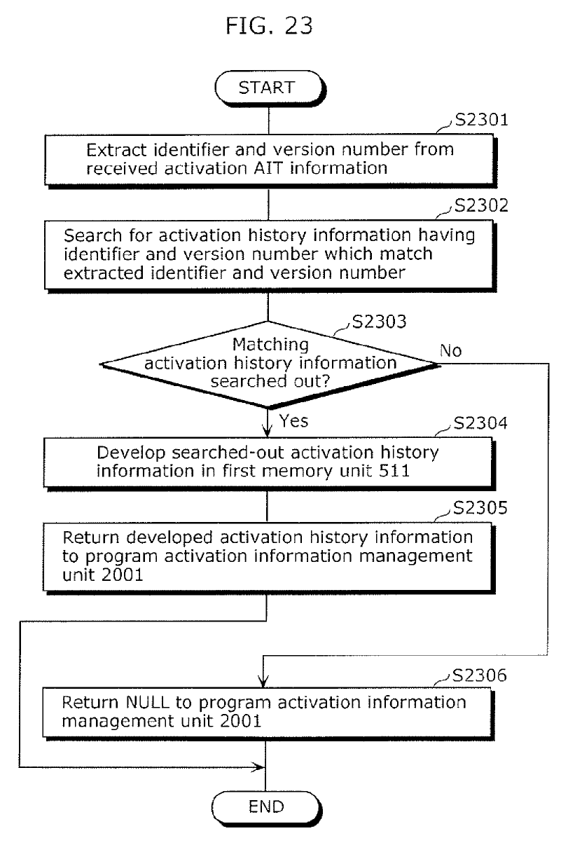

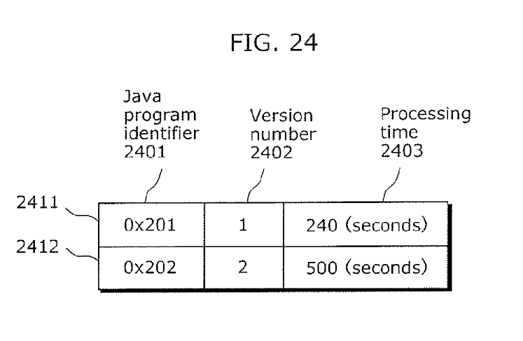

FIG. 23 is a flow chart indicating a sequence of actions of the program activation history information obtainment unit 2002 at the time when it receives, from the program activation information management unit 2001, the activation AIT information and a request for obtaining the activation history information of the Java (trademark) program. When the program activation history information obtainment unit 2002 receives, from the program activation information management unit 2001, the activation AIT information and the request for obtaining the activation history information, it extracts the identifier and the version number of the program from the received activation AIT information (Step 2301). Here, as for the identifier and the version number, the identifier 1801 and the version number 1805 in the line 1811 of FIG. 18 are used as examples. Next, the program activation history information obtainment unit 2002 searches activation history information as shown in FIG. 24 stored in the second memory 510 for activation history information having an identifier and a version number which match the identifier 1801 and the version number 1805 (Step 2302). FIG. 24 is a table that schematically shows an example of activation history information. A column 2401 describes identifiers of Java (trademark) programs, and each of the identifiers is compared with the identifier 1801 when the activation history information is searched. A column 2402 describes the version numbers of the Java (trademark) programs, and each of the version numbers is compared with the version number 1805 when the activation history information is searched. A column 2403 describes the processing time needed for download and activation (activation waiting time) of the Java (trademark) programs. The unit of processing time in the column 2403 is seconds in this embodiment, but it should be noted that any unit can be used as long as a time is measured on the unit basis. Columns 2411 and 2412 are a set of activation history information. Accordingly, the activation history information having values which match with the values of the identifier 1801 and the version number 1805 is the activation history information of the column 2411. The program activation history information obtainment unit 2002 judges whether matching activation history information is searched out (Step 2303) as the result of the search in Step 2302. In the case where the judgment result shows that it is searched out (Yes in Step 2303), the program activation history information obtainment unit 2002 develops the searched-out activation history information in the first memory 511 (Step 2304) and returns the developed activation history information to the program activation information management unit 2001 (Step 2305). The program activation history information obtainment unit 2002 judges whether matching activation history information is searched out (Step 2303) as the result of the search in Step 2302. In the case where the judgment result shows that it is not searched out (No in Step 2303), the program activation history information obtainment unit 2002 returns NULL which means that no activation history information exists to the program activation information management unit 2001 (Step 2306).

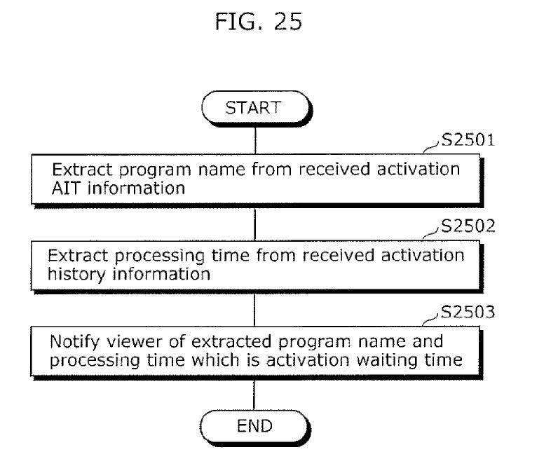

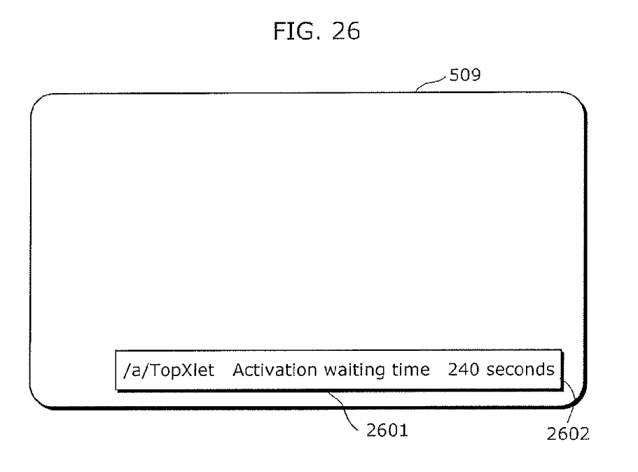

FIG. 25 is a flow chart indicating a sequence of actions of the program activation information notification unit 2005 at the time when it receives, from the program activation information management unit 2001, the activation AIT information and the activation history information. When the program activation information notification unit 2005 receives, from the program activation information management unit 2001, the activation AIT information, the activation history information and a notification request, it extracts the program name from the activation AIT information (Step 2501) and extracts the processing time from the activation history information (Step 2502). It is assumed here that the program name is the program name 1804 of “a/TopXlet” indicated by the fine 1811 of FIG. 18 and the processing time is the processing time 2403 of “240” seconds indicated by the line 2411 of FIG. 24. Next, the program activation information notification unit 2005 notifies the user of the extracted program name and processing time which is the activation waiting time (Step 2503). This is realized by means that the program activation information notification unit 2005 transmits, to the CPU 514 of the terminal device 500, the information related to the program name and the processing time to be displayed on the display screen of the terminal device 500, and a dialog display program included in the library is 1201b of the OS 1201 displays the information shown in FIG. 26 to the display screen 509. The dialog box 2601 has a display element which is a message 2602. It should be noted that the information to be extracted by the program activation information notification unit 2005 is not limited to a program name and processing time. Any method will do as long as it can provide information necessary for notifying a user of a processing time for download and activation of the program. The character string of the message 2602 is not limited to the character string in FIG. 26, and other character string will do. Additionally, the format of the message 2602 is not limited to the format of the character string of FIG. 26 and other format will do. In addition, the activation waiting time may be displayed using a countdown.

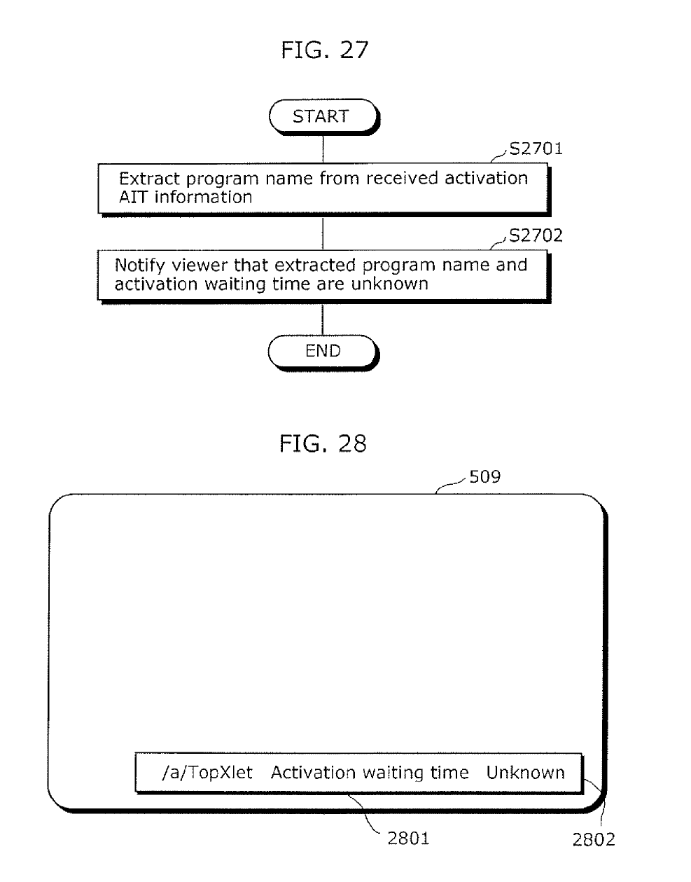

FIG. 27 is a flow chart indicating a sequence of actions of the program activation information notification unit 2005 at the time when it receives, from the program activation information management unit 2001, activation AIT information and a notification request. When the program activation information notification unit 2005 receives the activation AIT information and the notification request from the program activation information management unit 2001, it extracts the program name from the activation AIT information (Step 2701). It is assumed here that the program name is the program name 1804 of “a/TopXlet” indicated by the line 1811 of FIG. 18. Next, the program activation information notification unit 2005 notifies the user that the extracted program name and the processing time (activation waiting time) are unknown (Step 2702). This is realized by means that the program activation information notification unit 2005 transmits, to the CPU 514 of the terminal device 500, the information indicating that the program name and the processing time to be displayed on the display screen are unknown, and a dialog display program included in the library 1201b of the OS 1201 displays the information as shown in FIG. 28 on the display screen 509. 2801 is a dialog box, and has a display element which is a message 2802. It should be noted that the information to be extracted by the program activation information notification unit 2005 is not limited to a program name. Any method will do as long as it can provide information necessary for notifying a user of a processing time for download and activation of the program. The character string of the message 2802 is not limited to the character string in FIG. 28, and other character string will do. Additionally, the format of the message 2802 is not limited to the format of the character string of FIG. 28 and other format will do.

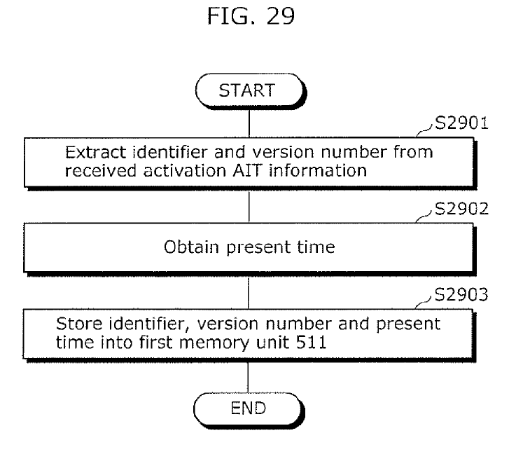

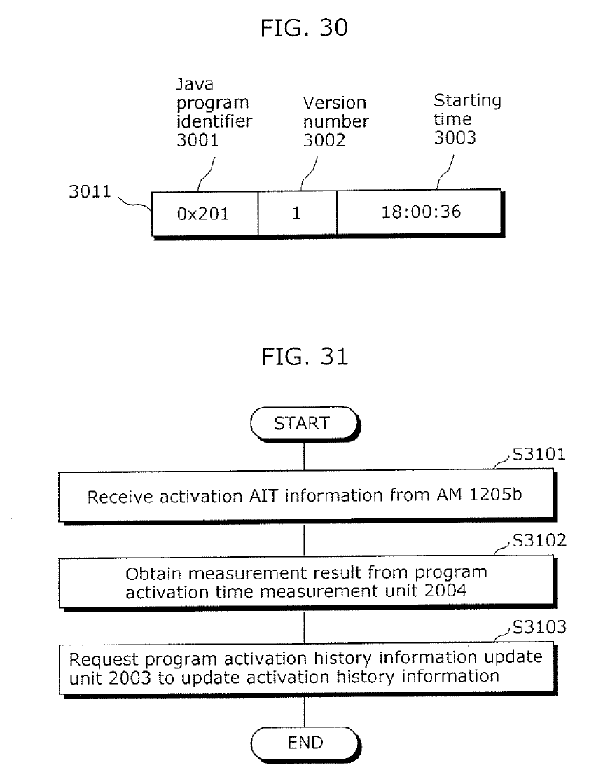

FIG. 29 is a flow chart indicating a sequence of actions of the program activation time measurement unit 2004 at the time when it receives a measurement request from the program activation information management unit 2001. When the program activation time measurement unit 2004 receives, from the program activation information management unit 2001, activation AIT information and a measurement request, it extracts the identifier and the version number from the activation AIT information (Step 2901). The program activation time measurement unit 2004 obtains present time (Step 2902). The program activation time measurement unit 2004 stores program activation time information 3011 in the first memory unit 511 (Step 2803) as shown in FIG. 30. The program activation time information 3011 is a set of an identifier 3001, a version number 3002 and a starting time 3003. The identifier 3001 is the identifier extracted in Step 2901, the version number 3002 is the version number extracted in Step 2901, and the starting time 3003 is the present time obtained in Step 2902.

Actions described next are: obtaining measurement result of a time needed for download and activation of a Java (trademark) program and updating the activation history information.

FIG. 31 is a flow chart indicating a sequence of actions of the program activation information management unit 2001. The actions are: obtaining measurement result of the time needed for download and activation of a Java (trademark) program and updating the activation history information. At the time when the AM 1205b completes activation of the Java (trademark) program, the program activation information management unit 2001 receives the activation AIT information from the AM 1205b (Step 3101). The program activation information management unit 2001 passes the activation AIT information to the program activation time measurement unit 2004 and obtains the measurement result (Step 3102). The program activation information management unit 2001 passes the program activation history information update unit 2003 the activation AIT information and the obtained measurement result, and requests it to update the activation history information (Step 3103).

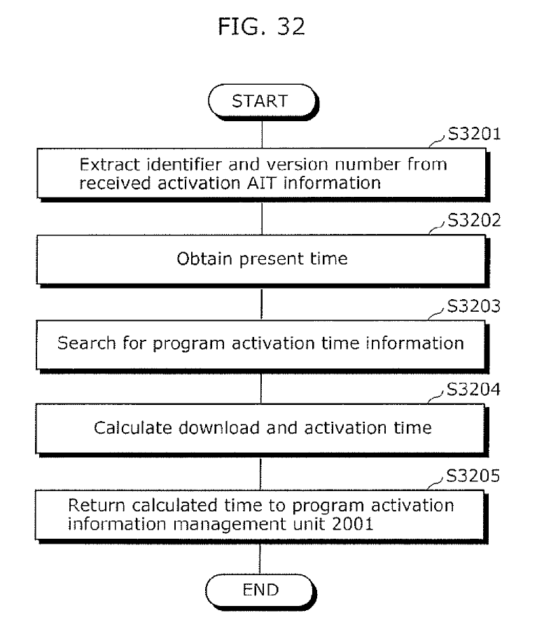

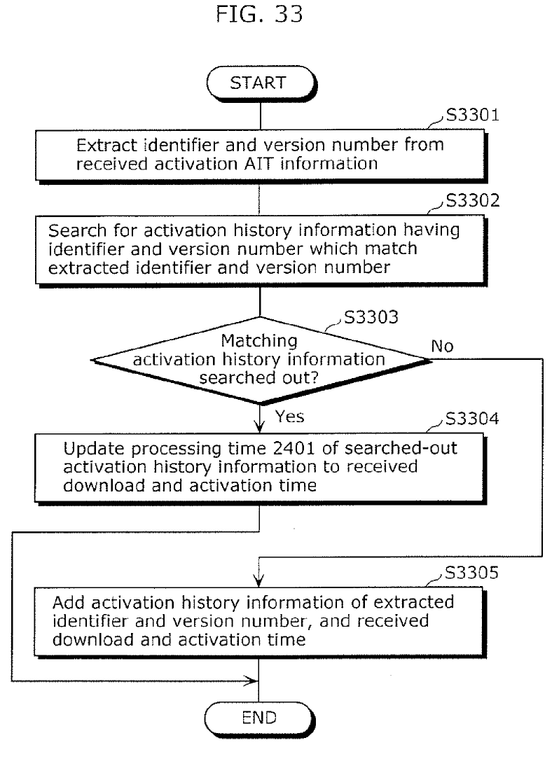

FIG. 32 is a flow chart indicating a sequence of actions of the program activation time measurement unit 2004 at the time when the program activation information management unit 2001 receives a request for obtaining a measurement result. When the program activation time measurement unit 2004 receives, from the program activation information management unit 2001, the activation AIT information and a request for obtaining the measurement result, it extracts the identifier and the version information from the activation AIT information (Step 3201). The program activation time measurement unit 2004 obtains a present time (Step 3202). The program activation time measurement unit 2004 searches program activation time information for matching program activation time information 3011 having the identifier and version number extracted in Step 3201 which match the identifier 3001 and the version number 3002 as shown in FIG. 30 stored in the first memory unit 511 (Step 3203). The program activation time measurement unit 2004 subtracts the starting time 3003 of the program activation time information 3011 searched out in Step 3203 from the present time obtained in Step 3202 so as to calculate the time needed for downloading and activating the program (Step 3204). The program activation time measurement unit 2004 returns the calculated time needed for the download and activation of the program to the program activation information management unit 2001 (Step 3205).

FIG. 33 is a flow chart indicating a sequence of actions of the program activation history information obtainment unit 2003 at the time when it receives, from the program activation information management unit 2001, the activation AIT information, the time needed for download and activation of a Java (trademark) program and an update request of the activation history information of the Java program. When the program activation history information obtainment unit 2003 receives, from the program activation information management unit 2001, the activation AIT information, the time needed for the download and activation and the update request of the activation history information, it extracts the identifier and the version number from the received activation AIT information (Step 3301). The program activation history information obtainment unit 2002 searches the activation history information shown in FIG. 24 stored in the second memory 510 for the activation history information having the identifier and version number which match the identifier and version number extracted in Step 3301 (Step 3302). The program activation history information obtainment unit 2002 judges whether matching activation history information is searched out (Step 3303) as a result of the search in Step 3302. In the case where the judgment result shows that it is searched out (Yes in Step 3303), the program activation history information obtainment unit 2002 updates the processing time 2403 of the searched-out activation history information stored in the second memory unit 510 to the time needed for the download and activation (Step 3304). The program activation history information obtainment unit 2002 judges whether matching activation history information is searched out (Step 3303) as a result of the search in Step 3302. In the case where the judgment result shows that it is not searched out (No in Step 3303), the program activation history information obtainment unit 2002 makes up the activation history information using the identifier and version number extracted in Step 3301 and the received time needed for the download and activation, and adds the activation history information to the activation history information stored in the second memory unit 510 (Step 3305).

Managing the activation history information of the Java (trademark) program in this way makes it possible to notify a user of the activation waiting time of the Java program.

### Second Embodiment

A service manager 1204 performs interactive communication with a headend 101 through a PODLib 1205e included in a library 1205. This interactive communication is realized by using the QPSK demodulation unit 502 and the QPSK modulation unit 503 through the library 1201b and a POD 504 of the OS 1201.

In addition, the service manager 1204 receives, from the headend 101, information or the Java (trademark) program that the terminal device 500 should store in the second memory unit 510 through this communication. Such information is referred to as XAIT information. The XAIT information is transmitted between the headend 101 and the POD 504 in an arbitrary form. The present invention can be implemented regardless of which transmission format is employed, as long as information required for an XAIT is included in the format.

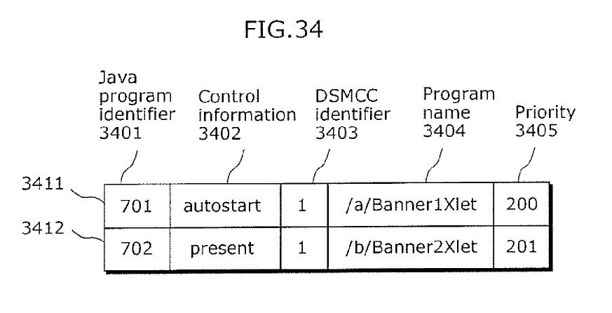

FIG. 34 illustrates a table that schematically shows an example of the XAIT information obtained from the headend 101. A column 3401 is the identifier of a Java (trademark) program. A column 3402 is control information for the Java (trademark) program. Such control information includes “autostart” and “present”, “autostart” means that the terminal device 500 automatically executes this program at the time when power to the terminal device 500 is turned on, and “present” means that the terminal device 500 does not automatically execute this program. A column 3403 is a DSMCC identifier for extracting the ID of a packet which includes the Java (trademark) program in the DSMCC format. A column 3404 is the program name of the Java (trademark program. A column 3405 is the priority of the Java (trademark) program. Lines 3411 and 3412 are a set of information of the Java (trademark) program. The Java (trademark) program defined by the line 3411 is a set of the identifier “701”, the control information “autostart”, the DSMCC identifier “1”, and the program name “a/Banner1Xlet”. Here, although only five items of information are specified for the Java (trademark) program, the present invention can be implemented even when more items of information are defined.

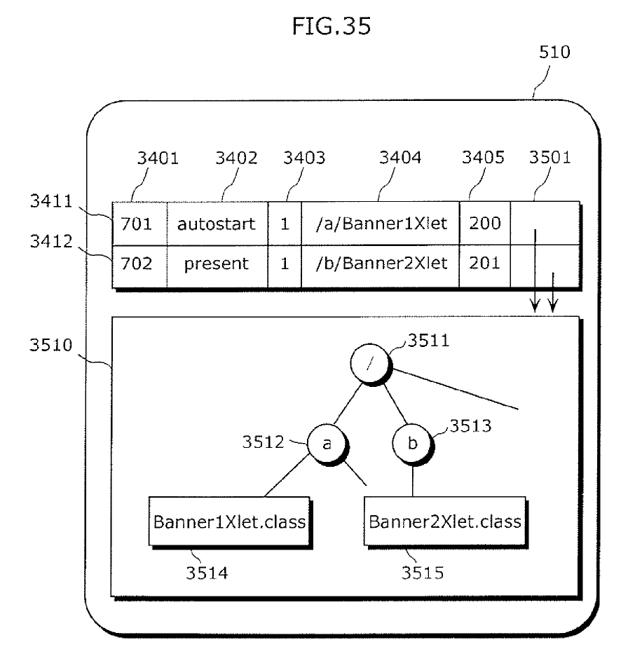

Upon receiving the XAIT information, the service manager 1204 stores the file system in the MPEG-2 transport stream into the first memory unit 511 according to the same procedure as the one used when the Java (trademark) program has been downloaded from the AIT information. Subsequently, it copies the stored file system in the second memory unit 510. Note that it is possible to implement direct download of the file system to the second memory unit 510 without using the first memory unit 511. Next, the service manager 1204 stores each XAIT information and the storage position of the downloaded file system which are associated with each other. FIG. 35 shows an example of the XAIT information and the downloaded file system which are stored in the second memory unit 510 in association with each other. Elements in FIG. 35 which are provided with the same reference numerals as those in FIG. 34 are the same as each other, and therefore descriptions of such elements are omitted. A column 3501 stores the storage position of each downloaded file system. In this figure, such storage positions are indicated by arrows. The column 3510 indicates a downloaded file system, and includes a top directory 3511, a directory “a” 3512, a directory “b” 3513, a file “Banner1Xlet. class” 3514, and a file “Banner2Xlet. class” 3515.

Here, the XAIT information is stored after the Java (trademark) program is stored, but it is also possible to store the XAIT information before the Java program is stored.

After power to the terminal device 500 is turned on, the OS 1201 specifies the service manager 1204 as a VM 1203, and the VM 1203 activates the service manager 1204. Subsequently, the service manager 1204 refers to the XAIT information which has been firstly stored in the second memory unit 510. Here, it refers to the control information of each Java (trademark) program, passes an “autostart” program to the VM 1203, and activates the program. Referring to FIG. 35, the Java (trademark) program “Banner1Xlet” defined by the line 3411 is activated.

Next, a function which will be described next is the function of obtaining history of a time and information related to download and activation of a Java (trademark) program which is the function of the present invention, and notifying a user of the history information.

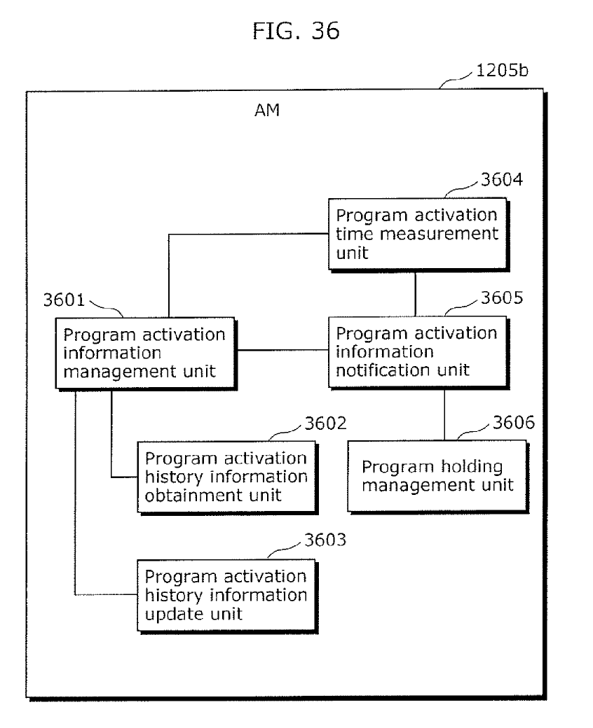

FIG. 36 shows only constituent elements of the AM 1205b at the time of executing the function of obtaining a time and information related to download and activation of the Java (trademark) program based on the XAIT information, and notifying the user of the history information. The other constituent elements are omitted because they are not directly related to the present invention.

As shown in FIG. 36, the AM 1205b includes: a program activation information management unit 3601, a program activation history information obtainment unit 3602, a program activation history information update unit 3603, a program activation time measurement unit 3604, a program activation information notification unit 3605 and a program holding management unit 3606.

Based on the XAIT information, the program activation information management unit 3601 makes: a request for obtaining activation history information of the Java (trademark) program; a request for notifying the activation history information and the like of the Java program; and a request for measuring the time needed for download and activation (download time and activation time) of the Java program. In addition, it obtains the measurement result of the download and activation time of the Java (trademark) program and makes a request for updating the activation history information of the Java program.

The program activation history information obtainment unit 3602 obtains history information of the Java (trademark) program which has been downloaded and activated, based on the request by the program activation information management unit 3601.

The program activation history information update unit 3603 updates the history information of the Java (trademark) program, based on the request by the program activation information management unit 3601.

The program activation time measurement unit 3604 measures a download and activation time of the Java (trademark) program, based on the request by the program activation information management unit 3601.

The program activation time notification unit 3605 notifies the Java (trademark) program, based on the request of the program activation information management unit 3601.

The program holding management unit 3606 manages the information of the Java (trademark) program which has been downloaded and stored in the second memory unit 510.

Firstly described actions are: obtaining request of activation history information of the Java (trademark) program, notifying the activation history information and the like, and measuring the time needed for download and activation.

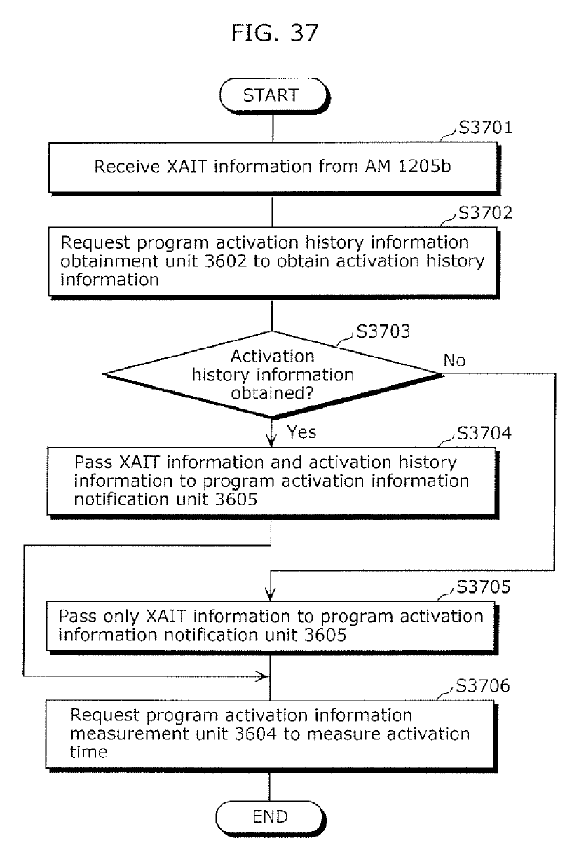

FIG. 37 is a flow chart indicating a sequence of the actions of the program activation information management unit 3601. The actions are: obtaining request of activation history information of the Java (trademark) program, notifying the activation history information and the like, and measuring the time needed for download and activation. At the time when the AM 1205b receives the XAIT information, the program activation information management unit 3601 receives, from the AM 1205b, the activation XAIT information received by the AM 1205b (Step 3701). The program activation information management unit 3601 passes the received XAIT information to the program activation history information obtainment unit 3602, and requests it Lo obtain the activation history information of the Java (trademark) program (Step 3702). The program activation information management unit 3601 judges whether the activation history information is obtained (Step 3703) as a result of the obtainment request in Step 3702. In the case where the judgment result of the obtainment request shows that it is obtained (Yes in Step 3703), the program activation information management unit 3601 passes the XAIT information and the obtained activation history information to the program activation information notification unit 3605, and requests it to notify them (Step 3704). The program activation information management unit 3601 judges whether the activation history information is obtained (Step 3703) as a result of the obtainment request in Step 3702. In the case where the judgment result of the obtainment request shows that it is not obtained (No in Step 3703), the program activation information management unit 3601 passes the XAIT information to the program activation information notification unit 3605, and requests it to notify the XAIT information (Step 3705). Lastly, the program activation information management unit 3601 passes the program activation time measurement unit 3604 the XAIT information, and requests it to measure the activation time (Step 3706).

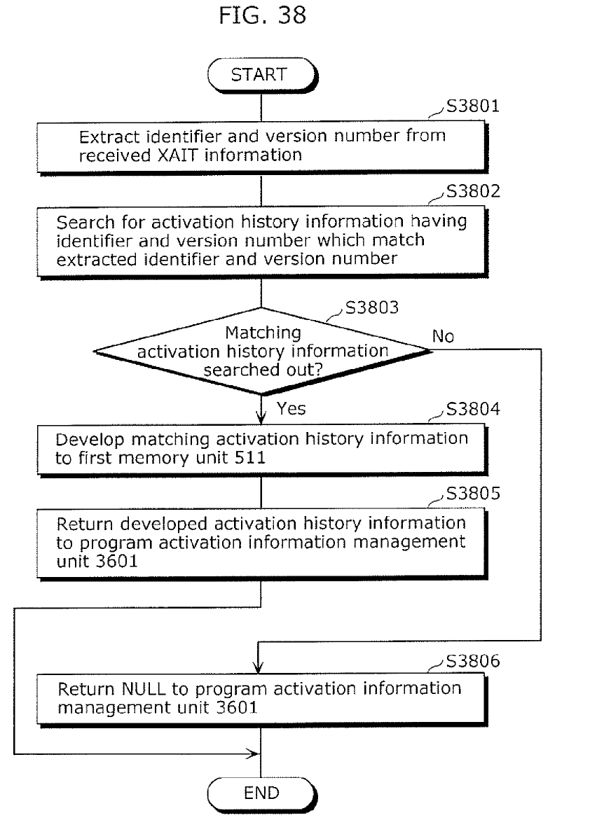

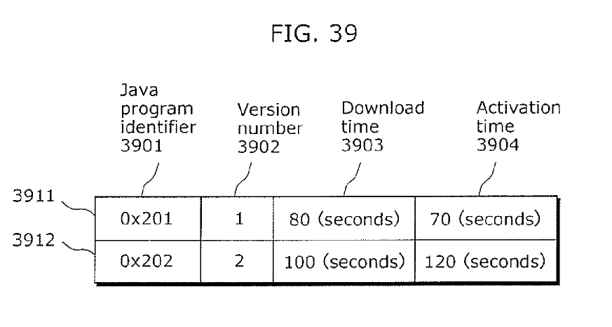

FIG. 38 shows a flow chart indicating a sequence of actions of the program activation history information obtainment unit 3602 at the time when it receives, from the program activation information management unit 3601, the XAIT information and a request for obtaining the activation history information of the Java (trademark) program. When the program activation history information obtainment unit 3602 receives, from the program activation information management unit 3601, the activation AIT information and the request for obtaining the activation history information, it extracts the identifier and the version number of the program from the received XAIT information (Step 3801). Here, as for the identifier and the version number, the identifier 3401 and the version number 3405 in the line 3411 of FIG. 34 are used as examples. Next, the program activation history information obtainment unit 3602 searches activation history information as shown in FIG. 39 stored in the second memory unit 510 for activation history information having the identifier and version number which match the identifier 3401 and version number 3405 (Step 3802). FIG. 39 is a table that schematically shows an example of activation history information. A column 3901 describes identifiers of Java (trademark) programs, and each of the identifiers is compared with the identifier 3401 when the activation history information is searched. A column 3902 describes the version numbers of the Java (trademark) programs, and each of the version numbers is compared with the version number 3405 when the activation history information is searched. A column 3903 describes a processing time needed for download (download time) of the Java (trademark) programs. A column 3904 describes a processing time needed for activation (activation time) of the Java (trademark) programs. The unit of a processing time in the columns 3903 and 3904 is seconds in this embodiment, but it should be noted that any unit can be used as long as a time is measured based on the unit. Columns 3911 and 3912 are a set of activation history information. Accordingly, the activation history information having the identifier and version number which match in value with the identifier 3401 and version number 3405 is the activation history information of the column 3911. The program activation history information obtainment unit 3602 judges whether a matching activation history information is searched out (Step 3803) as a result of the search in Step 3702. In the case where the judgment result shows that it is searched out (Yes in Step 3803), the program activation history information obtainment unit 3602 develops the searched-out activation history information in the first memory unit 511 (Step 3804) and returns the developed activation history information to the program activation information management unit 3501 (Step 3805). The program activation history information obtainment unit 3602 judges whether a matching activation history information is searched out (Step 3803) as a result of the search in Step 3802. In the case where the judgment result shows that it is not searched out (No in Step 3803), the program activation history information obtainment unit 3602 returns NULL which means that no activation history information exists to the program activation information management unit 3601 (Step 3806).

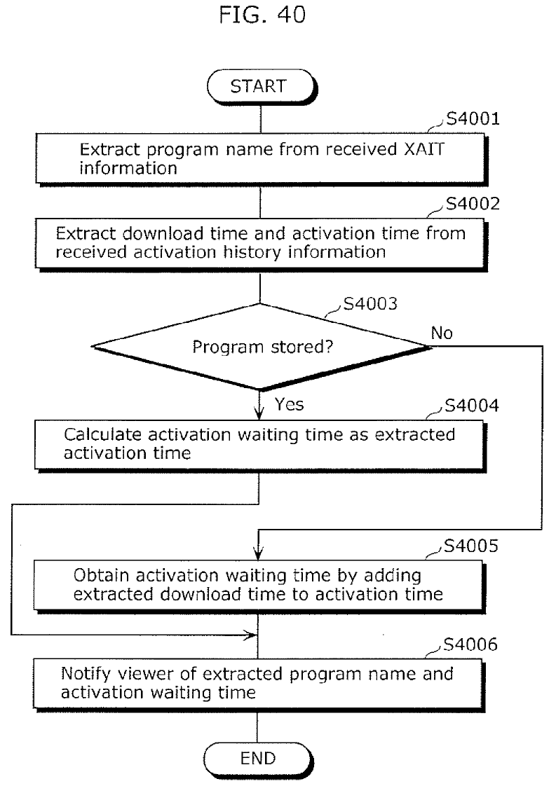

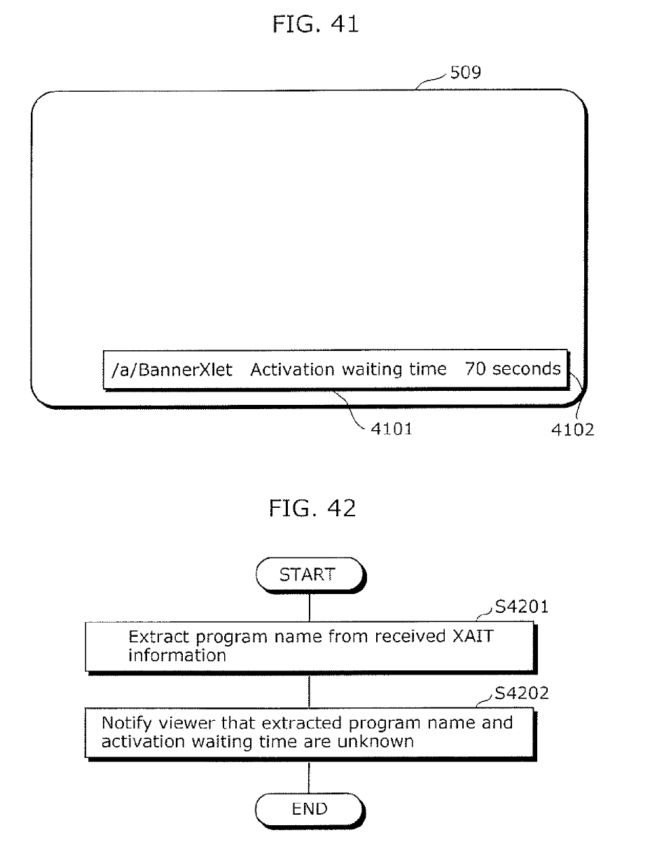

FIG. 40 is a flow chart indicating a sequence of actions of the program activation information notification unit 3605 at the time when it receives, from the program activation information management unit 3601, the XAIT information and the activation history information. When the program activation information notification unit 3605 receives, from the program activation information management unit 3601, the XAIT information, the activation history information and a request for notifying them, it extracts the program name from the XAIT information (Step 4001) and extracts the processing time from the activation history information (Step 4002). It is assumed here that the program name is the program name 3404 of “a/Banner1Xlet” indicated by the line 3411 of FIG. 34, the download time is the download time 3903 of “80” seconds indicated by the line 3911 or FIG. 39, and the activation time is the activation time 3904 of “70” seconds indicated by the line 3911 of FIG. 39. Next, the program activation information notification unit 3605 inquires of the program holding management unit 3606 whether this program is stored in the second memory unit 510 (Step 4003). In the case where this program is stored in Step 4003 (Yes in Step 4003), the program activation information notification unit 3605 calculates the activation waiting time as “70” seconds which is the activation time (Step 4004). More specifically, in the case where this program is stored in the second memory 510, there is no need to download the program. Thus, as shown in FIG. 21B, the time from the reception of an activation instruction for activating a program to the actual activation of the program is the activation waiting time. In the case where this program is not stored in Step 4003 (No in Step 4003), the program activation information notification unit 3605 obtains an activation waiting time, which is “150” seconds, by adding the download time of “80” seconds to the activation time of “70” seconds (Step 4005). More specifically, in the case where the program is not stored in the second memory unit 510, there is a need to download the program in a similar manner to the first embodiment. Thus, as shown in FIG. 21A, the time obtained by adding a download time to an activation time is an activation waiting time, of the program, which is the time from the reception of an activation instruction for activating a program to the actual activation of the program. Next, the program activation information notification unit 3605 notifies a user of the extracted program name and the calculated activation waiting time (Step 4006). This is realized by means that the program activation information notification unit 3605 transmits the program name and the activation waiting time to be displayed on the display screen to the CPU 514 of the terminal device 500, and the dialog display program included in the library 1201b of the OS 1201 displays the information as shown in FIG. 41 on the display screen 509. 4101 is a dialog box, and has a display element which is a message 4102. It should be noted that the information extracted by the program activation information notification unit 3605 is not limited to a program name, a download time and an activation time. Any method will do as long as it can provide information necessary for notifying a user of a processing time for download and activation of the program. The character string of the message 4102 is not limited to the character string in FIG. 41, and other character string will do. Additionally, the format of the message 4102 is not limited to the format of the character string of FIG. 41 and other format will do. In addition, the activation waiting time may be displayed using a countdown.

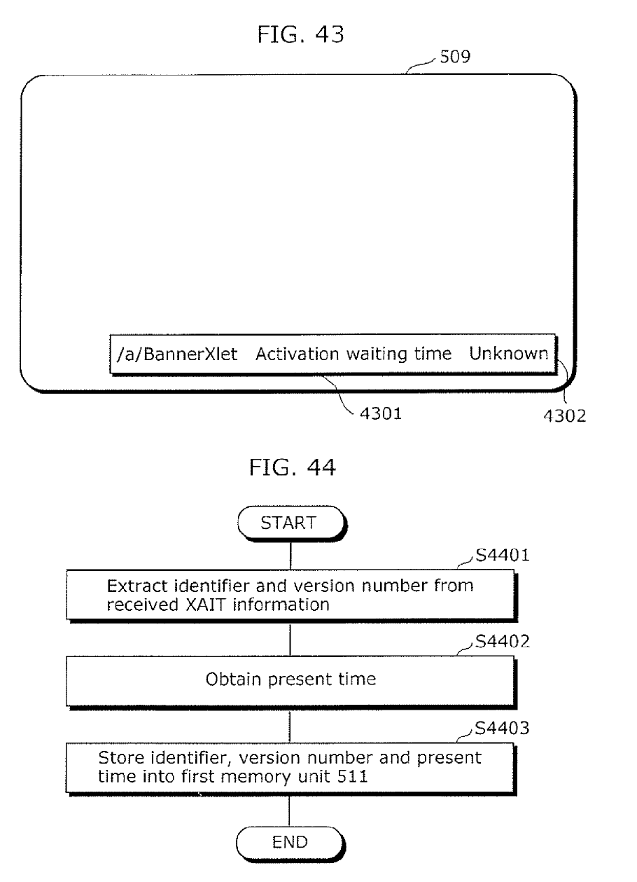

FIG. 42 is a flow chart indicating a sequence of actions of the program activation information notification unit 3605 at the time when it receives, from the program activation information management unit 3601, XAIT information and a notification request. When the program activation information notification unit 3605 receives the XAIT information and a notification request from the program activation information management unit 3601, it extracts the program name from the XAIT information (Step 4201). It is assumed here that the program name is the program name 3404 of “a/Banner1Xlet” indicated by the line 3411 of FIG. 34. Next, the program activation information notification unit 3605 notifies a user that the extracted program name and the activation waiting time are unknown (Step 4202). This is realized by means that the program activation information notification unit 3605 transmits, to the CPU 514 of the terminal device 500, the information indicating that the program name and the activation waiting time to be displayed on the display screen are unknown, and a dialog display program included in the library 1201b of the OS 1201 displays the information shown in FIG. 43 on the display screen 509. 4301 is a dialog box, and has a display element which is a message 4302. It should be noted that the information extracted by the program activation information so notification unit 3605 is not limited to a program name. Any method will do as long as it can provide information necessary for notifying a user of an activation waiting time which is a download and activation time of the program. The character string of the message 4302 is not limited to the character string in FIG. 43, and other character string will do. Additionally, the format of the message 4302 is not limited to the format of the character string of FIG. 43 and other format will do.

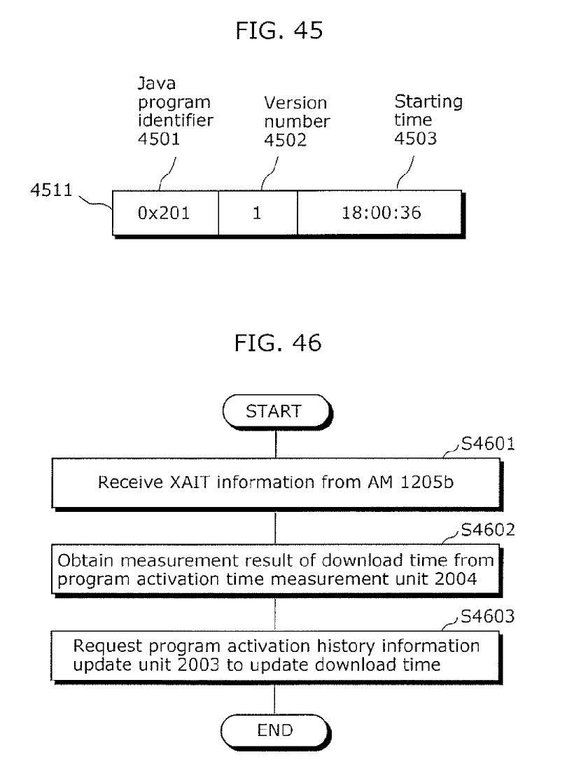

FIG. 44 is a flow chart indicating a sequence of actions of the program activation time measurement unit 3604 at the time when it receives a measurement request from the program activation information management unit 3601. When the program activation time measurement unit 3604 receives, from the program activation information management unit 3601, XAIT information and a measurement request, it extracts the identifier and the version number from the activation AIT information (Step 4401). The program activation time measurement unit 3604 obtains a present time (Step 4402). The program activation time measurement unit 3604 stores program activation time information 4511 in the first memory unit 511 (Step 4403) as shown in FIG. 45. The program activation time information 4511 is a set of an identifier 4501, a version number 4502 and a starting time 4503. The identifier 4501 is the identifier extracted in Step 4401, the version number 4502 is the version number extracted in Step 4401, and the starting time 4503 is the present time obtained in Step 4402.

Actions described next are: obtaining measurement result of the time needed for download and activation of a Java (trademark) program and updating the activation history information.

FIG. 46 is a flow chart indicating a sequence of actions of the program activation information management unit 3601. The actions are: obtaining measurement result of the time needed for download and activation of a Java (trademark) program and updating the activation history information. At the time when the AM 1205b completes download of the Java (trademark) program, the program activation information management unit 3601 receives the XAIT information from the AM 1205b (Step 4601). The program activation information management unit 3601 passes the XAIT information to the program activation time measurement unit 3604 and obtains the measurement result (Step 4602). The program activation information management unit 3601 passes the program activation history information update unit 3603 the XAIT information and the obtained measurement result of the download time, and requests it to update the download time (Step 4603).

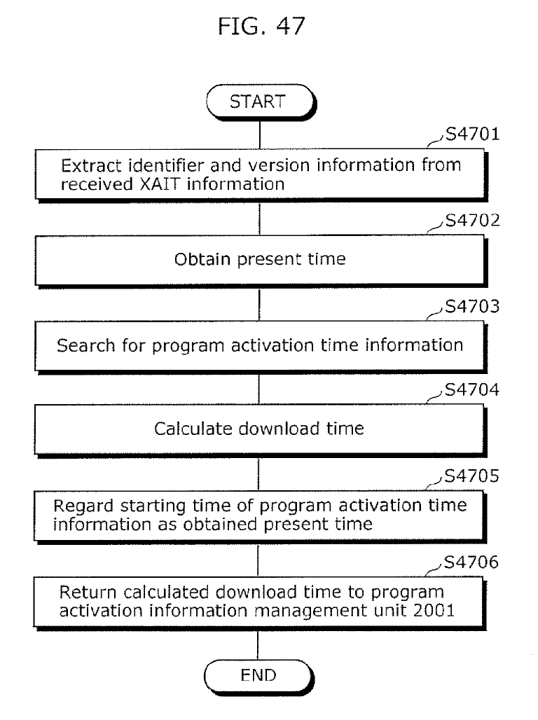

FIG. 47 is a flow chart indicating a sequence of actions of the program activation time measurement unit 3604 at the time when the program activation information management unit 3601 receives a request for obtaining a measurement result of the download time. When the program activation time measurement unit 3604 receives, from the program activation information management unit 3601, the XAIT information and a request for obtaining the measurement result, it extracts the identifier and the version information from the XAIT information (Step 4701). The program activation time measurement unit 3604 obtains present time (Step 4702). The program activation time measurement unit 3604 searches program activation time information for a matching program activation time information 4511 having the identifier and version number extracted in Step 4701 which match the identifier 4501 and version number 4502, as shown in FIG. 45, stored in the first memory unit 511 (Step 4703). The program activation time measurement unit 3604 subtracts the starting time 4503 of the program activation time information 4511 searched out in Step 4703 from the present time obtained in Step 4702 so as to calculate the download time of the program (Step 4704). The program activation time measurement unit 3604 regards the starting time 4503 of the program activation time information 4511 searched out in Step 4703 as the present time (Step 4705). The program activation time measurement unit 3604 returns the calculated download time to the program activation information management unit 3601 (Step 4706).

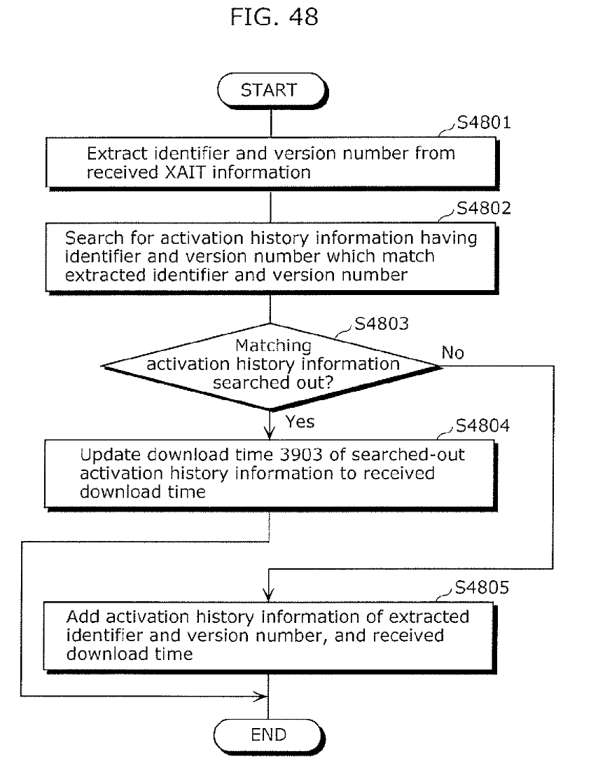

FIG. 48 is a flow chart indicating a sequence of actions of the program activation history information obtainment unit 3603 at the time when it receives, from the program activation information management unit 3601, the XAIT information, the download time of a Java (trademark) program and an update request of the activation history information of the Java program. When the program activation history information obtainment unit 3603 receives, from the program activation information management unit 3601, the XAIT information, the download time and the update request of the activation history information, it extracts the identifier and the version number from the received XAIT information (Step 4801). The program activation history information obtainment unit 3602 searches the activation history information shown in FIG. 39 stored in the second memory unit 510 for the activation history information having the identifier and version number which match the identifier and version number extracted in Step 4801 (Step 4802). The program activation history information obtainment unit 3602 judges whether matching activation history information is searched out (Step 4803) as a result of the search in Step 4802. In the case where the judgment result shows that it is searched out (Yes in Step 4803), the program activation history information obtainment unit 3602 updates the download time 3903 of the searched-out activation history information stored in the second memory unit 510 to the received download time (Step 4804). The program activation history information obtainment unit 3602 judges whether matching activation history information is searched out (Step 4803) as a result of the search in Step 4802. In the case where the judgment result shows that it is not searched out (No in Step 4803), the program activation history information obtainment unit 3602 makes up activation history information using the identifier and version number extracted in Step 4801, the download time and dummy activation time (for example, 0 second), and adds the activation history information to the activation history information stored in the second memory unit 510 (Step 4805).

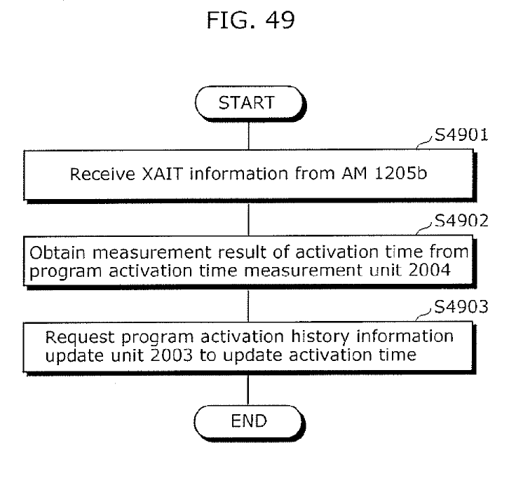

FIG. 49 is a flow chart indicating a sequence of actions of the program activation information management unit 3601. The actions are: obtaining a measurement result of the activation time of a Java (trademark) program and updating the activation history information. At the time when the AM 1205b completes activation of the Java (trademark) program, the program activation information management unit 3601 receives the XAIT information from the AM 1205b (Step 4901). The program activation information management unit 3601 passes the XAIT information to the program activation time measurement unit 3604 and obtains the measurement result of the activation time (Step 4902). The program activation information management unit 3601 passes the program activation history information update unit 3603 the XAIT information and the obtained measurement result of the activation time, and requests it to update the activation time (Step 4903).

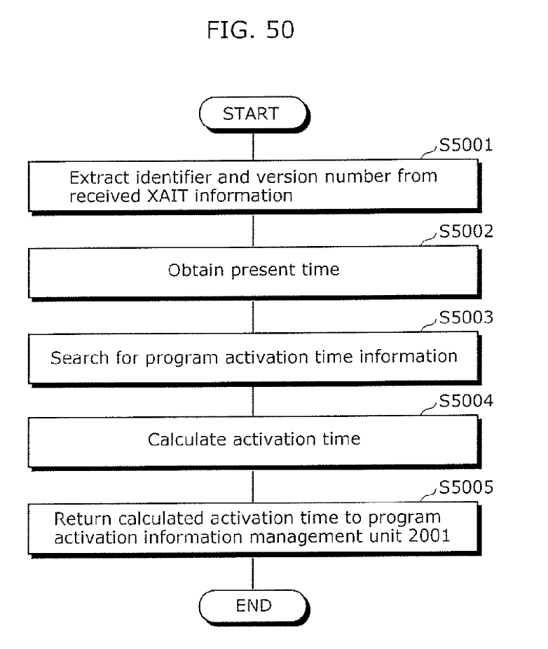

FIG. 50 is a flow chart indicating a sequence of actions of the program activation time measurement unit 3604 at the time when the program activation information management unit 3601 receives a request for obtaining the measurement result of the activation time. When the program activation time measurement unit 3604 receives, from the program activation information management unit 3601, the XAIT information and a request for obtaining the measurement result of the activation time, it extracts the identifier and the version information from the XAIT information (Step 5001). The program activation time measurement unit 3604 obtains present time (Step 5002). The program activation time measurement unit 3604 searches program activation time information for matching program activation time information 4511 having the identifier and version number extracted in Step 5001 which match the identifier 4501 and version number 4502, as shown in FIG. 45, stored in the first memory unit 511 (Step 5003). The program activation time measurement unit 3604 subtracts the starting time (download completion time) 4503 of the program activation time information 4511 searched out in Step 5003 from the present time obtained in Step 5002 so as to calculate the activation time of the program (Step 5004). The program activation time measurement unit 3604 returns the calculated activation time to the program activation information management unit 3601 (Step 5005).

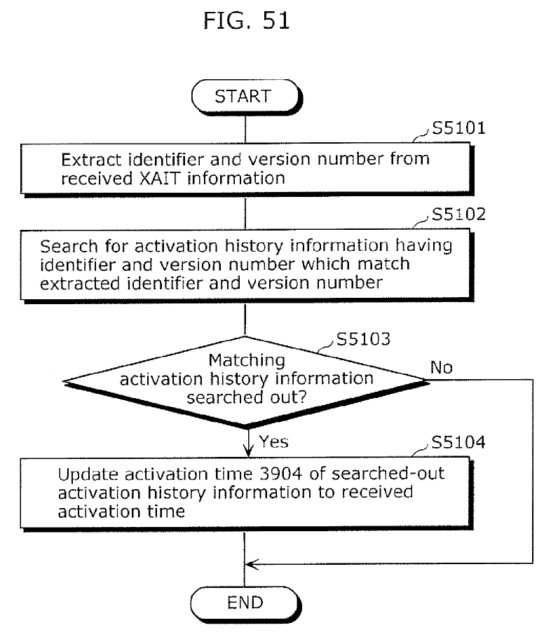

FIG. 51 is a flow chart indicating a sequence of actions of the program activation history information obtainment unit 3603 at the time when it receives, from the program activation information management unit 3601, the XAIT information, the activation time and an update request of the activation history information of the Java (trademark) program. When the program activation history information obtainment unit 3603 receives, from the program activation information management unit 3601, the XAIT information, the activation time and the update request of the activation history information, it extracts the identifier and the version number from the received XAIT information (Step 5101). The program activation history information obtainment unit 3602 searches the activation history information shown in FIG. 39 stored in the second memory 510 for the activation history information having the identifier and version number which match the identifier and version number extracted in Step 5101 (Step 5102). The program activation history information obtainment unit 3602 judges whether matching activation history information is searched out (Step 5103) as a result of the search in Step 5102. In the case where the judgment result shows that it is searched out (Yes in Step 5103), the program activation history information obtainment unit 3602 updates the activation time 3904 of the searched-out activation history information stored in the second memory unit 510 to the received activation time (Step 5104).

Managing the activation history information of a Java (trademark) program in this way makes it possible to notify a user of the activation waiting time of the Java program.

### Third Embodiment

Downloading a Java (trademark) program based on XAIT information has been described in the second embodiment. In this embodiment, further performing authentication processing of the Java (trademark) program will be described.

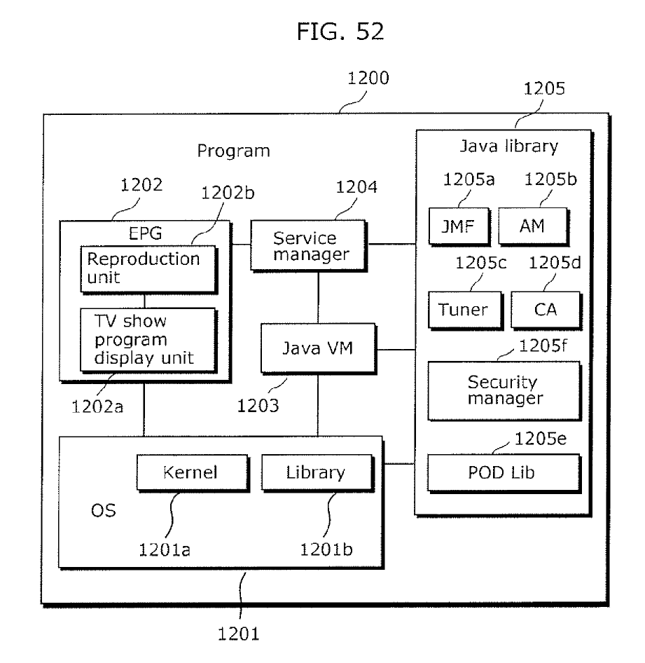

FIG. 52 is a diagram showing a structure of the program to be stored in a terminal device according to the present invention. Note that the same constituent elements as those in the second embodiment will not be described here again.

In this embodiment, as shown in FIG. 52, the Java library 1205 includes a security manager 1205f in addition to the configuration shown in FIG. 12. According to an instruction from the AM 1205b, the security manager 1205f performs proper authentication of the program to be executed on the terminal device depending on whether this program is stored in the second memory unit 510 or not. More specifically, in the case where the program is not stored in the second memory unit 510, the security manager 1205f performs: calculation of a hash value of the file system; hash value check of checking whether a hash value matches with the hash value which is present in the hash file; and route certification check of authenticating the certification such as a route certification. In the other case where the program is stored in the second memory unit 510, the security manager 1205f performs only route certification check of authenticating the certification such as a route certification. The MHP specifications define that whether the security manager 1205f of the terminal device 500 can judge whether such Java program should be authenticated or not based on the identifier of the Java (trademark) program as shown in the column 3401 of FIG. 34. Such authentication is not necessary in the case where the value of an identifier is within the range from 0x0 to 0x3fff, but an identifier having a value ranging from 0x4000 to 0x7fff must be authenticated.

In addition, the AM 1205b of this embodiment has the same configuration as the one in the second embodiment shown in FIG. 36, but the program activation time measurement unit 3604 acts differently. Note that the same constituent elements as those in the second embodiment will not be described here again.

The program activation time measurement unit 3604 measures the download time and activation time of the Java (trademark) program, based on a request of the program activation information management unit 3601. More specifically, in the case where the program for which an activation instruction is received is not stored in the second memory unit 510, the program activation time measurement unit 3604 includes the time needed for authentication of the program (authentication time in the download time in measuring the download time. In the case where the program for which an activation instruction is received is stored in the second memory unit 510, the program activation time measurement unit 3604 includes the time needed for authentication of the program (authentication time) in the download time in measuring the download time.

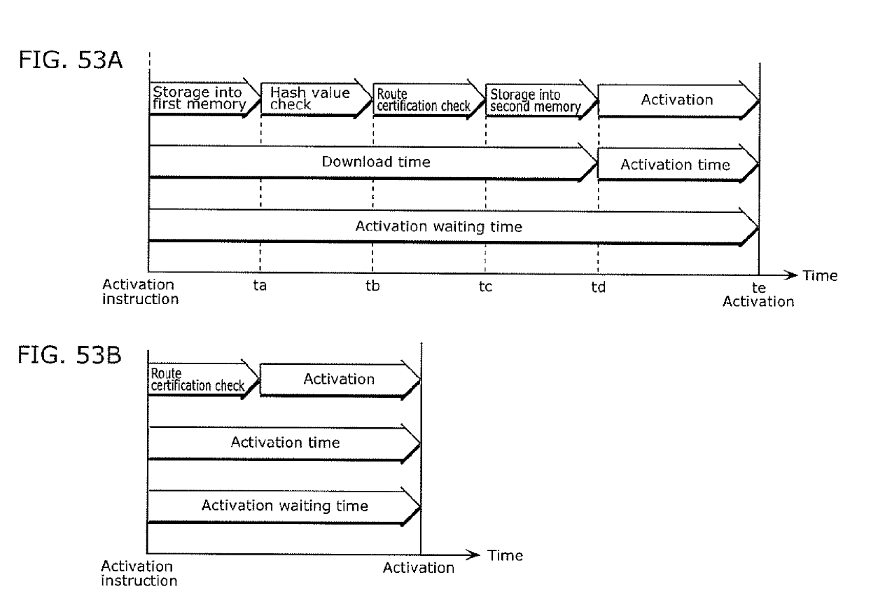

FIGS. 53A and 53B each is a diagram showing the relationship between an authentication time, a download time, an activation time and an activation waiting time. FIG. 53A shows the case of a program which needs to be downloaded, and FIG. 53B shows the case of a program which does not need to be downloaded.

In the case of a program which needs to be downloaded, the downloaded program is authenticated by security manager 1204f before being stored in the second memory unit 510. Thus, as shown in FIG. 53A, the download time is the total of: the time from when an activation instruction for activating a program is received to when the program is stored in the first memory unit 511; the time needed for checking the hash value for the program stored in the first memory unit 511; the time needed for checking a route certification for the program stored in the first memory unit 511; and the time from that time to when the program stored in the first memory 511 is stored in the second memory unit 510. The time needed for activation is the activation time.

In the other case where the program does not need to be downloaded, in other words, the program is stored in the second memory unit 510, the security manager 1205f performs authentication for route certification check only. Thus, as shown in FIG. 53B, the activation time is the total of: the time needed for route certification check for the program stored in the second memory unit 510; and the time needed for activation of the program.

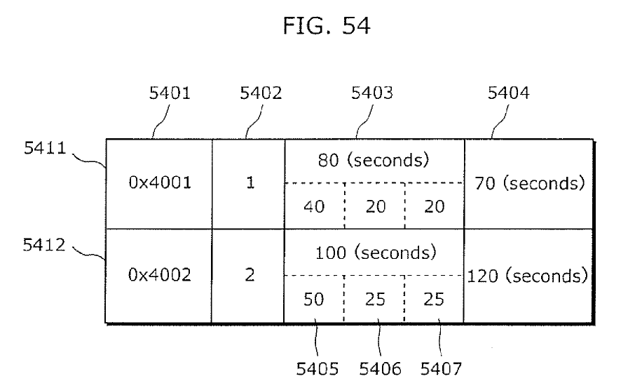

FIG. 54 is a table that schematically shows an example of activation history information. A column 5401 is the identifier of a Java (trademark) program. A column 5402 is the version number of the Java program. A column 5403 is the processing time needed for download (download time) of the Java program. A column 5404 is the processing time needed for activation (activation time) of the Java program. Further, the download time is managed as a storage time which is the total of: the time, indicated by the column 5405, which is needed for hash value check; the time, indicated by the column 5406, which is needed for route certification check; the time, indicated by the column 5407, which is the time from when an activation instruction for activating a program is received to when the program is stored in the first memory unit 511 and the time, also indicated by the column 5407, which is from that time to when the program stored in the first memory unit 511 is stored in the second memory unit 510. Here, the storage time is the total of: the time from when the activation instruction for activating the program is received to when the program is stored in the first memory unit 511 and the time from that time to when the program stored in the first memory unit 511 is stored in the second memory unit 510, but it should be noted that both the time may be managed separately.

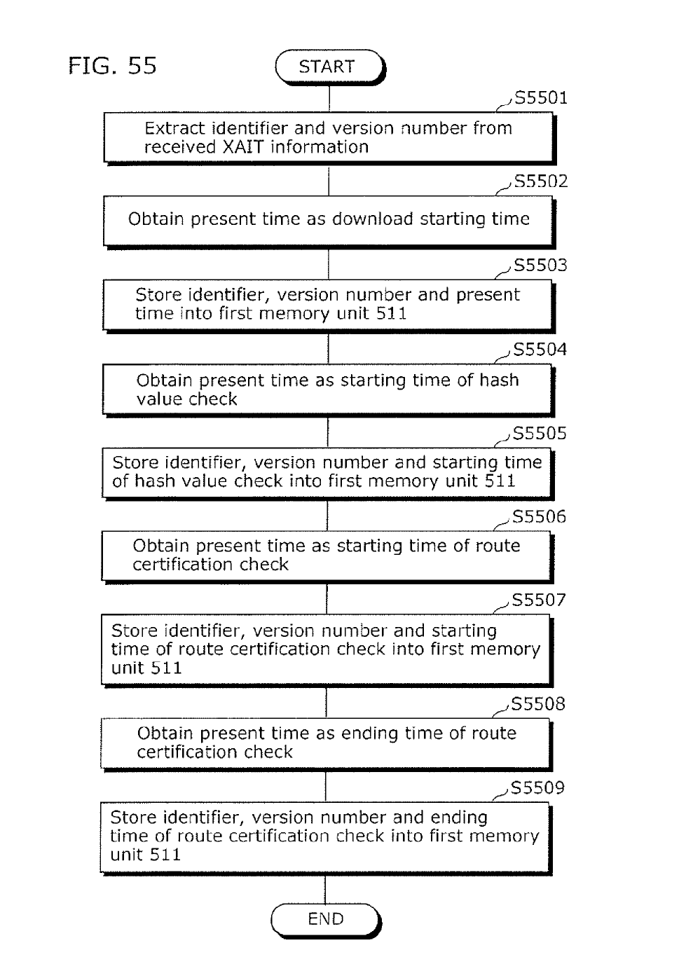

An action which will be described next is a measurement action of a download and activation time of a Java (trademark) program. FIG. 55 is a flow chart indicating a sequence of actions of the program activation time measurement unit 3604 at the time when a measurement request is made by the program activation information management unit 3601.

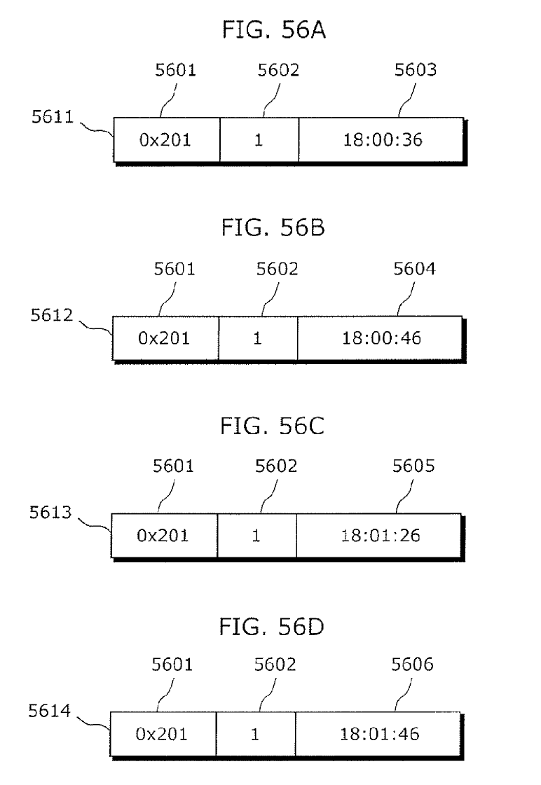

Upon receiving, from the program activation information management unit 3601, the XAIT information and the measurement request, the program activation time measurement unit 3604 extracts the identifier and the version number from the activation AIT information (Step 5501). The program activation time measurement unit 3604 obtains a present time as the download stating time (Step 5502). As shown in FIG. 56A, the program activation time measurement unit 3604 stores, in the first memory unit 511, program activation time information 5611 which is a set of the identifier 5601, the version number 5602, and the download starting time 5603 (Step 5503). Next, upon receiving a notification indicating the start of hash value check from the security manager 1205f, the program activation time measurement unit 3604 obtains a present time as the starting time of the hash value check (Step 5504). As shown in FIG. 56B, the program activation time measurement unit 3604 stores, in the first memory unit 511, program activation time information 5612 which is a set of the identifier 5601, the version number 5602, and the download starting time 5604 (Step 5505). Next, upon receiving a notification indicating the start of the hash value check from the security manager 1205f, the program activation time measurement unit 3604 obtains a present time as the starting time of the route certification check (Step 5506). As shown in FIG. 56C, the program activation time measurement unit 3604 stores, in the first memory unit 511, program activation time information 5613 which is a set of the identifier 5601, the version number 5602, and the download starting time 5605 (Step 5507). Next, upon receiving a notification indicating the completion of the route certification check from the security manager 1205f, the program activation time measurement unit 3604 obtains a present time as the ending time of the route certification check (Step 5508). As shown in FIG. 56D, the program activation time measurement unit 3604 stores, in the first memory unit 511, program activation time information 5614 which is a set of the identifier 5601, the version number 5602, and the download starting time 5606 (Step 5509).

In this way, the program activation time measurement unit 3604 stores each program activation time information in the first memory unit 511. Subsequently, at the time when download of the Java (trademark) program is completed, the program activation information management unit 3601 which received the XAIT information from the AM 1205b passes the XAIT information to the program activation time measurement unit 3604, and obtains a measurement result of the download time.

The program activation time measurement unit 3604 calculates a download time and activation time using each program activation time information shown in FIG. 56A to 56D, in a similar manner to the above-described second embodiment. It further calculates the contents of the download time; that is, the time needed for hash value check, the time needed for route certification check and the storage time.

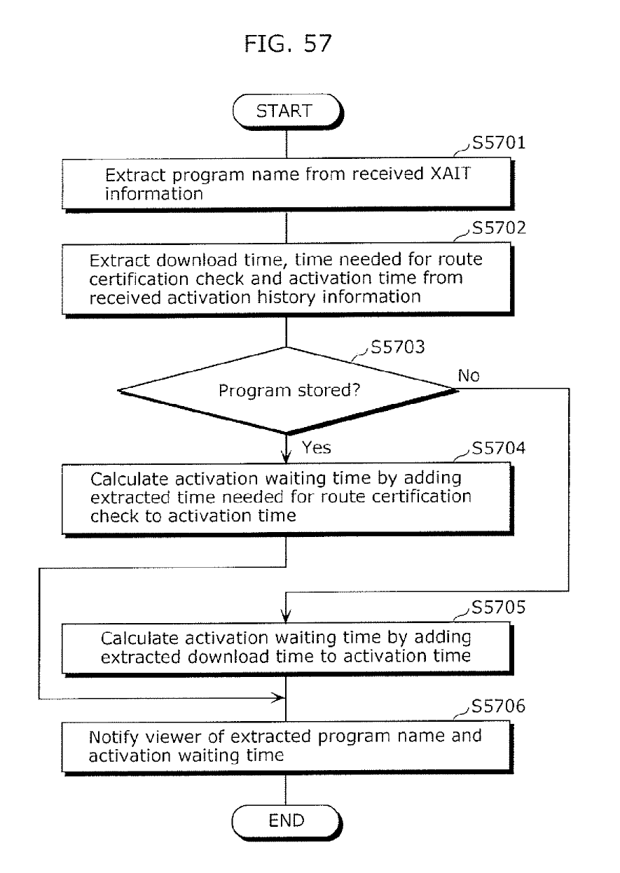

FIG. 57 is a flow chart indicating a sequence of actions of the program activation time notification unit 3605 at the time when it receives, from the program activation information management unit 3601, the XAIT information, the activation history information and the request for notifying them. Upon receiving, from the program activation information management unit 3601, the XAIT information, the activation history information and the notification request, the program activation information notification unit 3605 extracts the program name from the XAIT information (Step 5701) and extracts the download time, the activation time and the time needed for the route certification check from the XAIT information (Step 5702). It is assumed here that the download time is the download time 5403 of “80” seconds indicated by the line 5411 of FIG. 54, the activation time is the activation time 5404 of “70” seconds indicated by the line 5411 of FIG. 54, and the time needed for the route certification check is the time needed for route certification check 5406 of “20” seconds indicated by the line 5411 of FIG. 54. Next, the program activation information notification unit 3605 inquires of the program holding management unit 3606 whether this program is stored in the second memory unit 510 (Step 5703). In the case where it is stored in Step 5703 (Yes in S5703), the program activation information notification unit 3605 calculates the activation waiting time, which is “90” seconds, by adding the time needed for the route certification check of “20” seconds to the activation time of “70” seconds (Step 5704). More specifically, in the case where the program is stored in the second memory unit 510, there is no need to download the program, but route certification check needs to be performed. Therefore, as shown in FIG. 53B, the time obtained by adding the time needed for the route certification check to the activation time is the activation waiting time from the reception of an activation instruction for activating a program to the actual activation of the program. In the case where it is not stored in Step 5703 (No in S5703), the program activation information notification unit 3605 calculates the activation waiting time, which is “150” seconds, by adding the download time of “80” seconds to the activation time of “70” seconds (Step 5705). More specifically, in the case where the program is not stored in the second memory unit 510, there is a need to perform download similarly to the first embodiment. Therefore, as shown in FIG. 53A, the time obtained by adding the download time to the activation time is the activation waiting time; this is, the time from the reception of an activation instruction for activating a program to the actual activation of the program. Next, the program activation information notification unit 3605 notifies the user of the extracted program name and the calculated activation waiting time, similarly to the second embodiment (Step 5706).

Managing the activation history information of the Java (trademark) program in this way makes it possible to notify the user of the activation waiting time of the Java program.

In this embodiment, in the case where the program is not stored in the second memory unit 510, the security manager 1205f performs hash value check and route certification check before the downloaded program is stored in the second memory unit 510. However, the security manager 1205f may be configured to perform route certification check again between the time when the program is stored in the second memory unit 510 and the time immediately before the program is activated. In this case, the activation time includes the time needed for the route certification check. Therefore, in the case where the program is stored in the second memory unit 510, the activation time is the activation waiting time; that is, the time from the reception of an activation instruction for activating a program to the actual activation of the program.

In addition, the following applications are possible through the first to third embodiments.

The present invention is applicable to information devices such as personal computers and mobile telephones.

In addition, a POD 504 is configured to be detachably attached, but the present invention is implementable even when it is an embedded POD. In the case of such embedded POD, the present invention is implementable by detaching the CPU 706 from the POD 504 and allowing the CPU 514 to perform actions of the CPU 706.

In addition, a program is a Java (trademark) program, but the present invention is implementable by using a program other than such Java program.

In addition, the AM 1205b is configured to have main functional elements of the present invention such as; a program activation information management unit 2001, the program activation history information obtainment unit 2002, the program activation history information update unit 2003, the program activation time measurement unit 2004, and the program activation information notification unit 2005; and the program activation information management unit 3601, the program activation history information obtainment unit 3602, the program activation history information update unit 3603, the program activation time measurement unit 3604, the program activation information notification unit 3605, and the program holding management unit 3606. However, the present invention is implementable even when another module such as a monitor application described in the OCAP specifications is configured to have such functional elements. In addition, the present invention is implementable even by other embedded software.

### INDUSTRIAL APPLICABILITY

The present invention is applicable to a program execution device which downloads a program intended for a digital television, a personal computer, a mobile telephone or the like and executes the downloaded program.

1. A program execution device which downloads a program and activates the program, said device comprising:
a download time measurement unit operable to measure a download time of the program;
an activation time measurement unit operable to measure an activation time of the program;
a history information memory unit operable to store, on a program-by-program basis, the measured download time and activation time as a part of history information;
an activation management unit operable to receive an activation instruction for activating the program;
a history information search unit operable to search out history information of the program for which the activation instruction has been received; and
a notification unit operable to predict an activation waiting time based on the history information searched out by said history information search unit and notify a user of the predicted activation waiting time, the activation waiting time being a time from the reception of the activation instruction to an actual activation of the activation instruction.

2. The program execution device according to claim 1,
wherein said notification unit is operable to predict the activation waiting time which is a time obtained by adding the download time to the activation time included in the history information searched out by said history information search unit.

3. The program execution device according to claim 1, further comprising
a holding unit operable to hold the downloaded program,
wherein said notification unit is operable to predict, as the activation waiting time, a time obtained by adding the download time to the activation time included in the history information searched out by said history information search unit, in the case where the program for which the activation instruction has been received is not held in said holding unit, and is operable to predict, as the activation waiting time, the activation time included in the history information searched out by said history information search unit, in the case where the program for which the activation instruction has been received is held in said holding unit.

4. The program execution device according to claim 3, further comprising
an authentication unit operable to authenticate the program depending on whether or not the program is held in said holding unit,
wherein said download time measurement unit is operable to measure the download time including an authentication time required for said authentication unit to authenticate the program, in the case where the program for which the activation instruction has been received is not held in said holding unit, and is operable to measure the activation time including the authentication time required for said authentication unit to authenticate the program, in the case where the program for which the activation instruction has been received is held in said holding unit.

5. The program execution device according to claim 4, further comprising
an authentication judgment unit operable to judge whether or not the program needs to be authenticated by said authentication unit,
wherein said authentication unit is operable to authenticate the program in the case where said authentication unit has judged that the program needs to be authenticated.

6. The program execution device according to claim 1, further comprising
a history information update unit operable to update the history information stored in said history information memory unit using (a) the newly measured activation time or (b) the download time and activation time.

7. The program execution device according to claim 1,
wherein said notification unit is operable to notify the user of a program name of the program in addition to the activation waiting time.

8. The program execution device according to claim 1,
wherein said notification unit is operable to notify the activation waiting time using a countdown.

9. The program execution device according to claim 1,
wherein said notification unit is operable to predict that the activation waiting time is unknown, in the case where the history information of the program for which the activation instruction has been received cannot be obtained, as a result of the search performed by said history information search unit.

10. A program execution method for downloading a program and activates the program, said method comprising:
a download time measurement step of measuring a download time of the program;
an activation time measurement step of measuring an activation time of the program;
a history information memory step of storing, on a program-by-program basis, the measured download time and activation time as a part of history information;
an activation management step of receiving an activation instruction for activating the program;
a history information search step of searching out history information of the program for which the activation instruction has been received; and
a notification step of predicting an activation waiting time based on the history information searched out in said history information search step and notifying a user of the predicted activation waiting time, the activation waiting time being a time from the reception of the activation instruction to an actual activation of the activation instruction.

11. A program intended for downloading an execution program and activating the execution program, said program causing a computer to execute:
a download time measurement step of measuring a download time of the program;
an activation time measurement step of measuring an activation time of the program;
a history information memory step of storing, on a program-by-program basis, the measured download time and activation time as a part of history information;
an activation management step of receiving an activation instruction for activating the program;
a history information search step of searching out history information of the program for which the activation instruction has been received; and
a notification step of predicting an activation waiting time based on the history information searched out in said history information search step and notifying a user of the predicted activation waiting time, the activation waiting time being a time from the reception of the activation instruction to an actual activation of the activation instruction.

12. A recording medium on which a program is stored, the program being intended for downloading an execution program and activating the execution program so as to cause a computer to execute:
a download time measurement step of measuring a download time of the program;
an activation time measurement step of measuring an activation time of the program;
a history information memory step of storing, on a program-by-program basis, the measured download time and activation time as a part of history information;
an activation management step of receiving an activation instruction for activating the program;
a history information search step of searching out history information of the program for which the activation instruction has been received; and
a notification step of predicting an activation waiting time based on the history information searched out in said history information search step and notifying a user of the predicted activation waiting time, the activation waiting time being a time from the reception of the activation instruction to an actual activation of the activation instruction.
